(19) United States
(12) Patent Application Publication
(10) Pub. No.: US 2023/0222519 A1
(43) Pub. Date: Jul. 13, 2023

(54) SYSTEM FOR ISSUING NFTS BASED ON TICKET DATA AND METHODS FOR USE THEREWITH

(71) Applicant: Galiant Arts, LLC, Austin, TX (US)

(72) Inventors: Mark Meyers, Austin, TX (US); Bruce E. Stuckman, Austin, TX (US); John W. Howard, Cedar Park, TX (US); Brian G. Howard, Austin, TX (US); Gregory Meador, Austin, TX (US)

(73) Assignee: Galiant Arts, LLC, Austin, TX (US)

(21) Appl. No.: 18/187,117

(22) Filed: Mar. 21, 2023

Related U.S. Application Data
(63) Continuation-in-part of application No. 17/806,766, filed on Jun. 14, 2022.
Application No. 17/806,766 is a continuation-in-part of application No. 17/661,362, filed on Apr. 29, 2022.
Application No. 17/661,362 is a continuation-in-part of application No. 17/656,084, filed on Mar. 23, 2022.
(60) Provisional application No. 63/365,141, filed on May 23, 2022.
(60) Provisional application No. 63/365,143, filed on May 23, 2022.
(60) Provisional application No. 63/365,010, filed on May 19, 2022.
(60) Provisional application No. 63/365,012, filed on May 19, 2022.
(60) Provisional application No. 63/362,581, filed on Apr. 6, 2022.
(60) Provisional application No. 63/262,536, filed on Oct. 14, 2021.
(60) Provisional application No. 63/262,762, filed on Oct. 20, 2021.
(60) Provisional application No. 63/262,858, filed on Oct. 21, 2021.
(60) Provisional application No. 63/263,844, filed on Nov. 10, 2021.
(60) Provisional application No. 63/264,811, filed on Dec. 2, 2021.
(60) Provisional application No. 63/265,754, filed on Dec. 20, 2021.
(60) Provisional application No. 63/266,478, filed on Jan. 6, 2022.
(60) Provisional application No. 63/297,394, filed on Jan. 7, 2022.
(60) Provisional application No. 63/302,757, filed on Jan. 25, 2022.
(60) Provisional application No. 63/302,768, filed on Jan. 25, 2022.
(60) Provisional application No. 63/305,559, filed on Feb. 1, 2022.
(60) Provisional application No. 63/305,505, filed on Feb. 1, 2022.
(60) Provisional application No. 63/306,405, filed on Feb. 3, 2022.
(60) Provisional application No. 63/306,412, filed on Feb. 3, 2022.
(60) Provisional application No. 63/307,349, filed on Feb. 7, 2022.
(60) Provisional application No. 63/308,546, filed on Feb. 10, 2022.
(60) Provisional application No. 63/309,382, filed on Feb. 11, 2022.
(60) Provisional application No. 63/310,376, filed on Feb. 15, 2022.

(51) Int. Cl. G06Q 30/018

(52) U.S. Cl. CPC G06Q 30/0185

(57) ABSTRACT

A system operates by: receiving from a client device, via a network interface, a read request associated with an NFT, the NFT associated with an event; receiving from the client device, via the network interface, ticket data associated with a ticket to the event; determining, via a processor, when the ticket data conforms with event data associated with the event; and sending the NFT to the client device via the network interface when the ticket data conforms with the event data associated with the event.

### CROSS REFERENCE TO RELATED APPLICATIONS

The present U.S. Utility patent application claims priority pursuant to 35 U.S.C. § 119(e) to U.S. Provisional Application No. 63/365,141, entitled “SYSTEM FOR ISSUING NFTS BASED ON TICKET DATA AND METHODS FOR USE THEREWITH”, filed May 23, 2022; and U.S. Provisional Application No. 63/365,143, entitled “CLIENT DEVICE FOR DOWNLOADING NFTS BASED ON TICKET DATA AND METHODS FOR USE THEREWITH”, filed May 23, 2022, both of which are hereby incorporated herein by reference in their entirety and made part of the present U.S. Utility patent application for all purposes.

The present U.S. Utility patent application claims priority pursuant to 35 U.S.C. § 120 as a continuation-in-part of U.S. Utility application Ser. No. 17/806,766, entitled “SYSTEM FOR VALIDATING TICKET TRANSACTIONS VIA TICKET NFTS AND METHODS FOR USE THEREWITH”, filed Jun. 14, 2022, which claims priority pursuant to 35 U.S.C. § 119(e) to U.S. Provisional Application No. 63/365,010, entitled “SYSTEM FOR VALIDATING TICKET TRANSACTIONS VIA TICKET NFTS AND METHODS FOR USE THEREWITH”, filed May 19, 2022; and U.S. Provisional Application No. 63/365,012, entitled “METHOD AND SYSTEM FOR AUTHENTICATING TICKET NFT TRANSACTIONS IN REALTIME”, filed May 19, 2022, both of which are hereby incorporated herein by reference in their entirety and made part of the present U.S. Utility patent application for all purposes.

U.S. Utility application Ser. No. 17/806,766 also claims priority pursuant to 35 U.S.C. § 120 as a continuation-in-part of U.S. Utility application Ser. No. 17/661,362, entitled “SYSTEM FOR VALIDATING PLAY OF GAME APPLICATIONS VIA GAME NFTS AND METHODS FOR USE THEREWITH”, filed Apr. 29, 2022, which claims priority pursuant to 35 U.S.C. § 119(e) to U.S. Provisional Application No. 63/362,581, entitled “SYSTEM FOR VALIDATING PLAY OF GAME APPLICATIONS VIA GAME NFTS AND METHODS FOR USE THEREWITH”, filed Apr. 6, 2022, both of which are hereby incorporated herein by reference in their entirety and made part of the present U.S. Utility patent application for all purposes.

U.S. Utility application Ser. No. 17/661,362 also claims priority pursuant to 35 U.S.C. § 120 as a continuation-in-part of U.S. Utility application Ser. No. 17/656,084, entitled “FACILITATING PLAY OF GAME NFTS VIA A CLIENT DEVICE”, filed Mar. 23, 2022, which claims priority pursuant to 35 U.S.C. § 119(e) to 35 U.S.C. § 119(e) to U.S. Provisional Application No. 63/262,536, entitled “NFT COLLECTION PLATFORM AND METHODS FOR USE THEREWITH”, filed Oct. 14, 2021; U.S. Provisional Application No. 63/262,762, entitled “NFT COLLECTION PLATFORM FOR PROCESSING NFTS AND DATA AND METHODS FOR USE THEREWITH”, filed Oct. 20, 2021; U.S. Provisional Application No. 63/262,858, entitled “NFT COLLECTION PLATFORM FOR PROCESSING NFTS AND DATA AND METHODS FOR USE THEREWITH”, filed Oct. 21, 2021; U.S. Provisional Application No. 63/263,844, entitled “NFT COLLECTION PLATFORM FOR RENDERING NFTS IN AN ENVIRONMENT AND METHODS FOR USE THEREWITH”, filed Nov. 10, 2021; U.S. Provisional Application No. 63/264,811, entitled “CLIENT DEVICE FOR NFTS AND METHODS FOR USE THEREWITH”, filed Dec. 2, 2021; U.S. Provisional Application No. 63/265,754, entitled “REAL ESTATE NFTS AND METHODS FOR USE THEREWITH”, filed Dec. 20, 2021; U.S. Provisional Application No. 63/266,478, entitled “AUTHENTICATED LICENSE NFTS AND METHODS FOR USE THEREWITH”, filed Jan. 6, 2022; U.S. Provisional Application No. 63/297,394, entitled “GENERATION OF ENHANCEMENT NFTS AND METHODS FOR USE THEREWITH”, filed Jan. 7, 2022; U.S. Provisional Application No. 63/302,757, entitled “GENERATION OF NFT GALLERIES AND METHODS FOR USE THEREWITH”, filed Jan. 25, 2022; U.S. Provisional Application No. 63/302,768, entitled “ENHANCEMENT OF REAL ESTATE NFTS VIA NFT GALLERIES”, filed Jan. 25, 2022; U.S. Provisional Application No. 63/305,559, entitled “AUTHENTICATING NFT TRANSACTIONS VIA CONDITIONAL NFTS”, filed Feb. 1, 2022; U.S. Provisional Application No. 63/305,505, entitled “GENERATING A SECURE REAL-TIME NFT REPOSITORY FOR AUTHENTICATING NFT TRANSACTIONS”, filed Feb. 1, 2022; U.S. Provisional Application No. 63/306,405, entitled “GENERATING NFTS WITH FRACTIONAL RIGHTS IN ASSETS”, filed Feb. 3, 2022; U.S. Provisional Application No. 63/306,412, entitled “GENERATING NFTS WITH FRACTIONAL RIGHTS IN A COLLECTABLE”, filed Feb. 3, 2022; U.S. Provisional Application No. 63/307,349, entitled “STREAMING OF VIDEO NFTS TO A CLIENT DEVICE”, filed Feb. 7, 2022; U.S. Provisional Application No. 63/308,546, entitled “NODE NFTS WITH TRANSACTION UPDATES”, filed Feb. 10, 2022; U.S. Provisional Application No. 63/309,382, entitled “GENERATING PLAYABLE GAME NFTS”, filed Feb. 11, 2022; and U.S. Provisional Application No. 63/310,376, entitled “GENERATING UPDATED TEAM NFTS BASED ON TEAM DATA”, filed Feb. 15, 2022, all of which are hereby incorporated herein by reference in their entirety and made part of the present U.S. Utility patent application for all purposes.

### TECHNICAL FIELD

The present disclosure relates to processing systems and applications used in the collection, generation, display and use of non-fungible tokens (NFTs) or other digital tokens.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

FIG. 1A presents a block diagram representation of an example system.

FIG. 1B presents a block diagram representation of an example non-fungible token (NFT) collection platform.

FIG. 2 presents a block diagram representation of an example client device.

FIG. 3A presents a flowchart representation of an example method.

FIGS. 3B-3F and 3H present pictorial representations of example screen displays.

FIG. 3G presents a flow diagram representation of an example process.

FIG. 3I presents a flowchart representation of an example method.

FIG. 4A presents a flowchart representation of an example method.

FIG. 4B presents a pictorial representation of an example screen display.

FIG. 4C presents a flow diagram representation of an example process.

FIG. 5A presents a flowchart representation of an example method.

FIGS. 5B and 5C present pictorial representations of example screen displays.

FIG. 6 presents a block diagram/flow representation of an example of NFT generation.

FIG. 7 presents a block diagram representation of an example system.

FIG. 8 presents a block diagram representation of an example client device.

FIG. 9A presents a block diagram/flow representation of an example of NFT generation.

FIG. 9B presents a pictorial representation of an example NFT.

FIG. 9C presents a pictorial representation of an example improvement.

FIG. 9D presents a pictorial representation of an example NFT.

FIG. 9E presents a flowchart representation of an example method.

FIG. 10A presents a block diagram/flow representation of an example of NFT generation.

FIG. 10B presents a flowchart representation of an example method.

FIG. 11A presents a block diagram/flow representation of an example of NFT generation.

FIG. 11B presents a pictorial representation of an example NFT.

FIG. 11C presents a pictorial representation of example enhancements.

FIG. 11D presents a pictorial representation of an example NFT.

FIG. 11E presents a flowchart representation of an example method.

FIG. 12A presents a block diagram representation of an example system.

FIG. 12B presents a flowchart representation of an example method.

FIGS. 12C-12D present a block/flow diagram representations of example systems.

FIG. 12E presents a flowchart representation of an example method.

FIG. 12F presents a flowchart representation of an example method.

FIG. 12G presents a block diagram of an example system.

FIG. 12H presents a flowchart representation of an example method.

FIG. 12I presents a flowchart representation of an example method.

FIG. 12J presents a flowchart representation of an example method.

FIG. 12K presents a flowchart representation of an example method.

FIG. 12L presents a flowchart representation of an example method.

FIG. 12M presents a flowchart representation of an example method.

FIG. 12N presents a flowchart representation of an example method.

FIG. 12O presents a pictorial block diagram/flow representation of an example of transaction authentication.

FIG. 12P presents a pictorial block diagram/flow representation of an example of transaction authentication.

FIG. 12Q presents a pictorial block diagram/flow representation of an example of transaction authentication.

FIG. 12R presents a flowchart representation of an example method.

FIG. 12S presents a flowchart representation of an example method.

FIG. 12T presents a flowchart representation of an example method.

FIG. 13A presents a schematic/block diagram representation of an example system.

FIG. 13B presents a pictorial/flow representation of an example of NFT distribution.

FIG. 13C presents a pictorial/flow representation of an example of NFT distribution.

FIG. 13D presents a pictorial/flow representation of an example of NFT distribution.

FIG. 13E presents a pictorial/flow representation of an example of NFT distribution.

FIG. 13F presents a flowchart representation of an example method.

FIG. 13G presents a flowchart representation of an example method.

FIG. 13H presents a flowchart representation of an example method.

FIG. 13I presents a flowchart representation of an example method.

FIG. 13J presents a flowchart representation of an example method.

FIG. 13K presents a schematic/block diagram representation of an example system.

FIG. 13L presents a flowchart representation of an example method.

FIG. 14A presents a flowchart representation of an example method.

FIG. 14B presents a flowchart representation of an example method.

FIG. 14C presents a flowchart representation of an example method.

FIG. 14D presents a flowchart representation of an example method.

FIG. 14E presents a flowchart representation of an example method.

FIG. 14F presents a flowchart representation of an example method.

### DETAILED DESCRIPTION

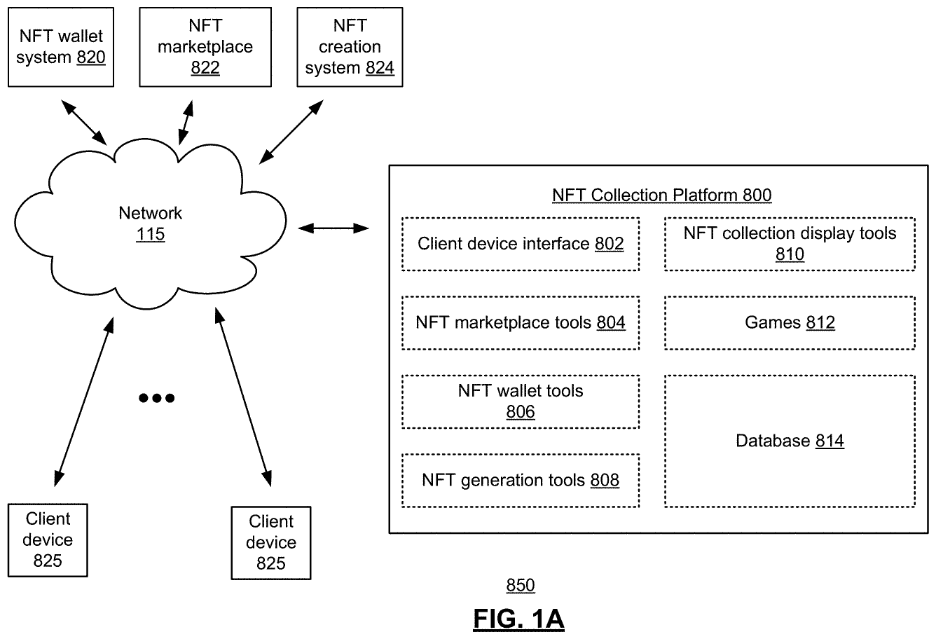

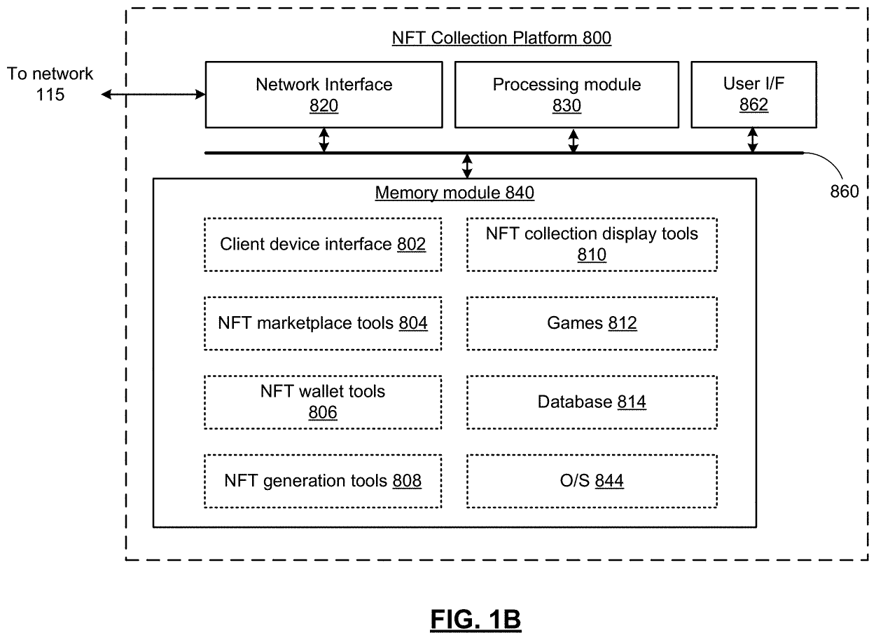

FIG. 1A presents a block diagram representation of an example system in accordance with various examples. In particular, a system 850 is presented that includes an NFT collection platform 800 that communicates with client devices 825 via a network 115. The network 115 can be the Internet or other wide area or local area network, either public or private. The client devices 825 can be computing devices such as laptops, smartphones, smart watches, tablets, desktops, or other computing devices associated with users, for example, buyers, sellers, collectors and/or users of NFTs.

NFT creation and ownership is growing worldwide. Existing platforms provide tools to create NFTs, marketplaces for buying and selling NFTs and wallets to securely hold them. Many NFT purchasers however, view NFTs similarly to cryptocurrency, purely as financial investments to be collected and later sold. Unlike cryptocurrencies which are fungible tokens, NFTs have a non-fungible (e.g. unique or limited) component that can correspond to photographs, graphics, art, video, games or other media or imagery that can be displayed, used in authentication and/or to provide other support for transactions and/or used in game play and for other utilitarian purposes, etc.

In the example shown, the NFT collection platform 800 includes a client device interface 802 for interacting with the client devices 825, NFT marketplace tools 804, NFT wallet tools 806, NFT generation tools 808, NFT collection display tools 810, one or more games 812 that can be played using NFTs that have been collected including game NFTs that include and/or otherwise associated with, or correspond to, playable game content, and a database 814 for storing user and account information, preferences, display settings and other data associated with users of the NFT collection platform 800. The NFT collection platform 800 can include or be implemented via one or more servers, a cloud computing system, an InterPlanetary File System (IPFS) or other decentralized or distributed computer system of individual computers and/or nodes and/or a centralized computing system.

For example, the client device interface 802 can operate in conjunction with each client device 825 and via network 115 to generate a graphical user interface. This graphical user interface is based on display data generated by the NFT collection platform 800 in a format for display on a display device associated with the client devices 825. This graphical user interface generates input data that is received by the NFT collection platform 800 from the client devices 825 in response to user interaction with the graphical user interface.

In various examples, the NFT collection platform 800 can serve the needs of a collector of NFTs by providing a system that offers new experiences that support various collector and/or use behaviors in the NFT world and metaverse including the collection, display, and use of NFTs and their corresponding content. The NFT collection display tools 810 can include a high-fidelity customizable page builder so each collector can personalize and display their NFTs in an environment. The NFT collection platform 800 can provide and support a collection social media site that, for example, is similar to MySpace, Facebook, or OnlyFans, but specifically directed to the arrangement, posting, sharing and/or display of collections of NFTs.

In the most basic mode of operation, the NFT collection platform 800 improves the technology of NFT systems by allowing the user to collect, arrange and display NFTs they have purchased so that the user, and other users, can enjoy and admire the NFTs they have collected. The NFT collection platform 800 not only allows users to curate, display and use their collections, to play games associated with their NFTs and/or also allows users to create a social/professional profile of their NFT property—enabling users to get creative with how their collections are presented, used and displayed. In addition, when a group of NFTs is collected and/or when a personalized/curated collection page, set and/or collection display is built, the NFT collection platform 800 improves the technology of NFT systems by allowing the user to mint a new “collection NFT” using blockchain-based, distributed computer network, and/or other crypto-based NFT creation techniques, for example and authenticated based on the user's ownership of the underlying NFTs.

Furthermore, the NFT collection platform 800 allows users to buy, sell, loan, borrow and trade NFTs with other users, including their own collection NFTs created based on their own collections. In various examples, the NFT collection platform 800 may not include a NFT creator, marketplace or wallet itself. The NFT generation tools 808, NFT wallet tools 806 and NFT marketplace tools 804 can reside on the NFT collection platform 800 and interface with one or more NFT wallet systems 820, NFT marketplaces 822 and/or NFT creation systems 824 to enable transactions/interactions/abilities at a metaverse level, offering collectors new and unique experiences, pre and post purchase, across all different NFT's and blockchains in one place. The NFT collection platform 800 improves the technology of NFT systems by allowing the user to perform the functions above in a fashion, that can be blockchain, wallet, and marketplace agnostic.

It should be noted that the system 850 can operate via blockchain-based technologies. In blockchain, a growing list of records, called “blocks”, are linked together using cryptography and spread over a decentralized computer system/network or other distributed network of participants. Each block contains a cryptographic hash of the previous block, a timestamp, and transaction data (generally represented as a Merkle tree). The timestamp proves that the transaction data existed when the block was published in order to get into its hash. As blocks each contain information about the block previous to it, they form a chain, with each additional block reinforcing the ones before it. Therefore, blockchains are resistant to modification of their data because once recorded, the data in any given block cannot be altered retroactively without altering all subsequent blocks. The distributed nature of this process over different nodes, the contemporaneous nature of geographically distinct calculations, coupled with the extreme computational complexity of the required calculations means that these blockchain-based technologies cannot practically be performed by the human mind.

It should be noted, that while the NFT wallet system 820, NFT marketplace 822 and NFT creation system 824 are shown as separate entities and as being external to the NFT collection platform 800, other configurations are possible where two or more of these entities share a common platform and/or the functions and features of one or more of these entities can be incorporated within the NFT collection platform 800 itself.

It should also be noted that while client device interface 802, NFT marketplace tools 804, NFT wallet tools 806, NFT generation tools 808, NFT collection display tools 810, games 812 and database 814 are shown as being internal to the NFT collection platform 800, in other examples, any subset of the various elements of the NFT collection platform 800 can be implemented external to the NFT collection platform 800 and coupled to the other components via the network 115. Furthermore, the NFT collection platform 800 can be implemented in a cloud computing configuration with any or all of the various elements of the NFT collection platform 800 implemented within the cloud.

The further operation of this system will be described in greater detail in conjunction with the figures that that follow, including many optional functions and features and examples thereof.

FIG. 1B presents a block diagram representation of an NFT collection platform 800 in accordance with various examples. In particular, the NFT collection platform 800 includes a network interface 820 such as a 3G, 4G, 5G or other cellular wireless transceiver, a Bluetooth transceiver, a WiFi transceiver, UltraWideBand transceiver, WIMAX transceiver, ZigBee transceiver or other wireless interface, a Universal Serial Bus (USB) interface, an IEEE 1394 Firewire interface, an Ethernet interface or other wired interface and/or other network card or modem for communicating for communicating via the network 115.

The NFT collection platform 800 also includes a processing module 830 and memory module 840 that stores an operating system (O/S) 844 such as an Apple, Unix, Linux or Microsoft operating system or other operating system, client device interface 802, NFT marketplace tools 804, NFT wallet tools 806, NFT generation tools 808, NFT collection display tools 810, games 812 and database 814. In particular, the O/S 844, the client device interface 802, NFT marketplace tools 804, NFT wallet tools 806, NFT generation tools 808, NFT collection display tools 810, and games 812 each include operational instructions that, when executed by the processing module 830, cooperate to configure the processing module 830 into a special purpose device to perform the particular functions of the NFT collection platform 800 described herein.

The NFT collection platform 800 may include a user interface (I/F) 862 such as a display device, touch screen, key pad, touch pad, joy stick, thumb wheel, a mouse, one or more buttons, a speaker, a microphone, an accelerometer, gyroscope or other motion or position sensor, video camera or other interface devices that provide information to an administrator of the NFT collection platform 800 and that generate data in response to the administrator's interaction with NFT collection platform 800.

The processing module 830 can be implemented via a single processing device or a plurality of processing devices. Such processing devices can include a microprocessor, micro-controller, digital signal processor, microcomputer, central processing unit, quantum computing device, field programmable gate array, programmable logic device, state machine, logic circuitry, analog circuitry, digital circuitry, and/or any device that manipulates signals (analog and/or digital) based on operational instructions that are stored in a memory, such as memory 840. The memory module 840 can include a hard disc drive or other disc drive, read-only memory, random access memory, volatile memory, non-volatile memory, static memory, dynamic memory, flash memory, cache memory, and/or any device that stores digital information. Note that when the processing device implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. While a particular bus architecture is presented that includes a single bus 860, other architectures are possible including additional data buses and/or direct connectivity between one or more elements. Further, the NFT collection platform 800 can include one or more additional elements that are not specifically shown.

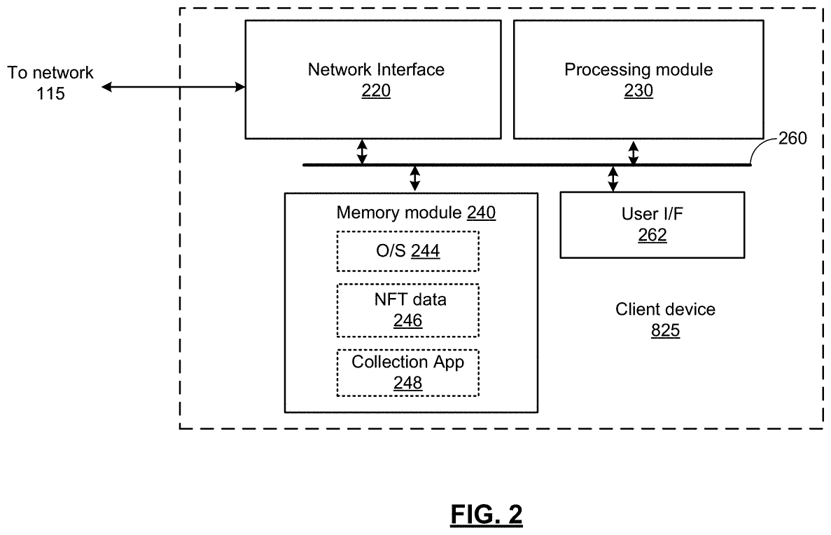

FIG. 2 presents a block diagram representation of an example client device in accordance with various examples. In particular, a client device 825 is presented that includes a network interface 220 such as a 3G, 4G, 5G or other cellular wireless transceiver, a Bluetooth transceiver, a WiFi transceiver, UltraWideBand transceiver, WIMAX transceiver, ZigBee transceiver or other wireless interface, a Universal Serial Bus (USB) interface, an IEEE 1394 Firewire interface, an Ethernet interface or other wired interface and/or other network card or modem for communicating for communicating via network 115.

The client device 825 also includes a processing module 230 and memory module 240 that stores an operating system (O/S) 244 such as an Apple, Unix, Linux or Microsoft operating system or other operating system, NFT data 246 associated with one or more NFTs owned by the user, and/or a collection applications 248. In particular, the O/S 244 and collection application 248 each include operational instructions that, when executed by the processing module 230, cooperate to configure the processing module into a special purpose device to perform the particular functions of the client device 825 described herein.

The client device 825 also includes a user interface (I/F) 262 such as a display device, touch screen, key pad, touch pad, joy stick, thumb wheel, a mouse, one or more buttons, a speaker, a microphone, an accelerometer, gyroscope or other motion or position sensor, video camera or other interface devices that provide information to a user of the client device 825 and that generate data in response to the user's interaction with the client device 825.

The processing module 230 can be implemented via a single processing device or a plurality of processing devices. Such processing devices can include a microprocessor, micro-controller, digital signal processor, microcomputer, central processing unit, quantum computing device, field programmable gate array, programmable logic device, state machine, logic circuitry, analog circuitry, digital circuitry, and/or any device that manipulates signals (analog and/or digital) based on operational instructions that are stored in a memory, such as memory 240. The memory module 240 can include a hard disc drive or other disc drive, read-only memory, random access memory, volatile memory, non-volatile memory, static memory, dynamic memory, flash memory, cache memory, and/or any device that stores digital information. Note that when the processing device implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. While a particular bus architecture is presented that includes a single bus 260, other architectures are possible including additional data buses and/or direct connectivity between one or more elements. Further, the client device 825 can include one or more additional elements that are not specifically shown.

The client device 825 operates, via network interface 220, network 115 and NFT collection platform 800. In various examples, the client device 825 operates to display a graphical user interface generated based on display data from the NFT collection platform 800, including corresponding screen displays. Furthermore, the graphical user interface can operate in response to interactions by a user to generate input data that is sent to the NFT collection platform 800 to control the operation of the NFT collection platform 800 and/or to provide other input.

It should be noted that while the client devices 825 and NFT collection platform 800 are shown as separate devices that communicate via the network 115, it should be noted that any and all of the functionality attributed to the NFT collection platform 800, including the NFT marketplace tools 804, NFT wallet tools 806, NFT generation tools 808, NFT collection display tools 810, games 812, and database 814, etc. can likewise be incorporate directly into the client device 825. In this fashion, a client device 825 through the application of its operating system 244 and one or more applications can provide a graphical user interface to operate via network 115 but independently from any NFT collection platform to perform any of the functions and features described herein. In particular, the client device 825 can perform the functions of both the client device and the NFT collection platform 800 without requiring communications to be sent to the client device 825 from a NFT collection platform and communications sent to a NFT collection platform from the client device 825.

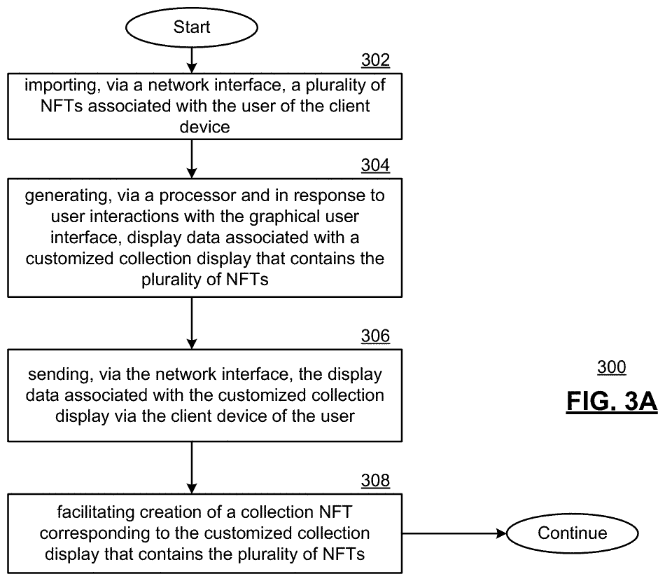

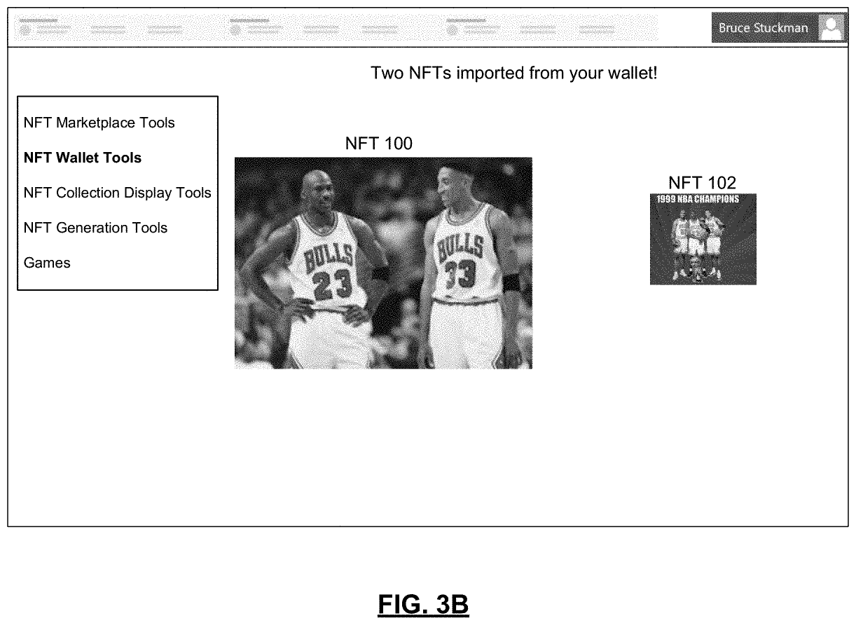

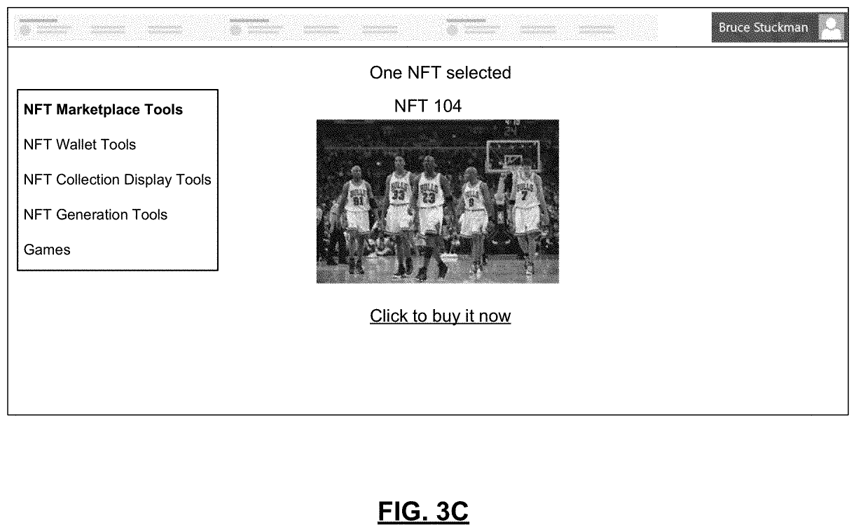

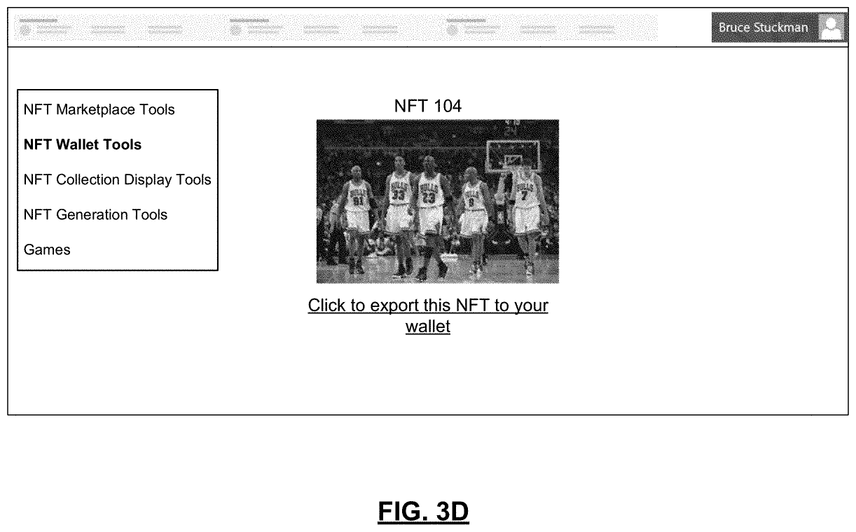

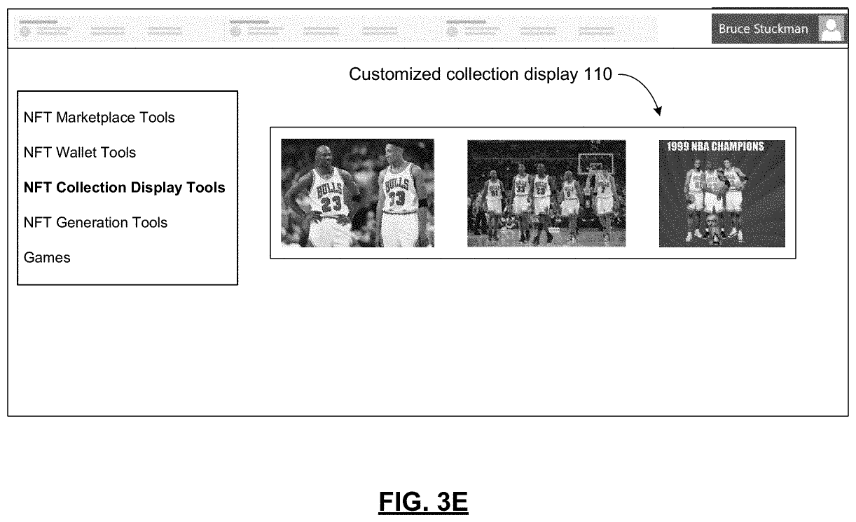

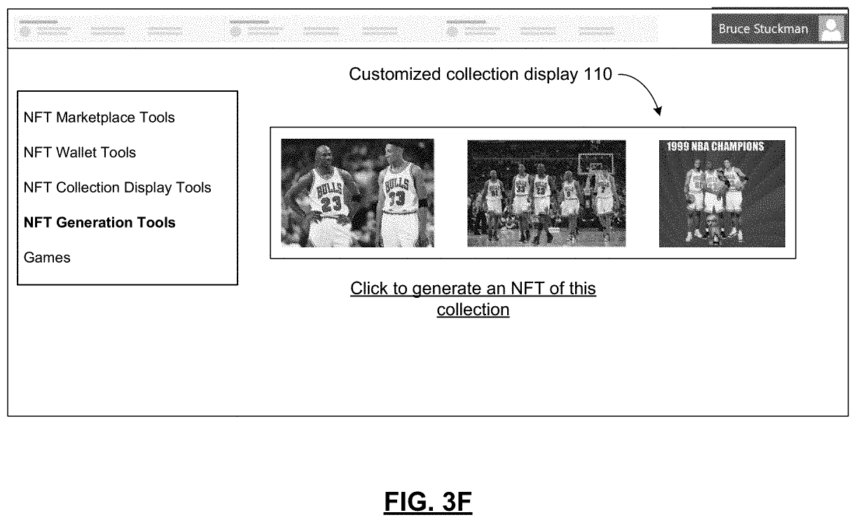

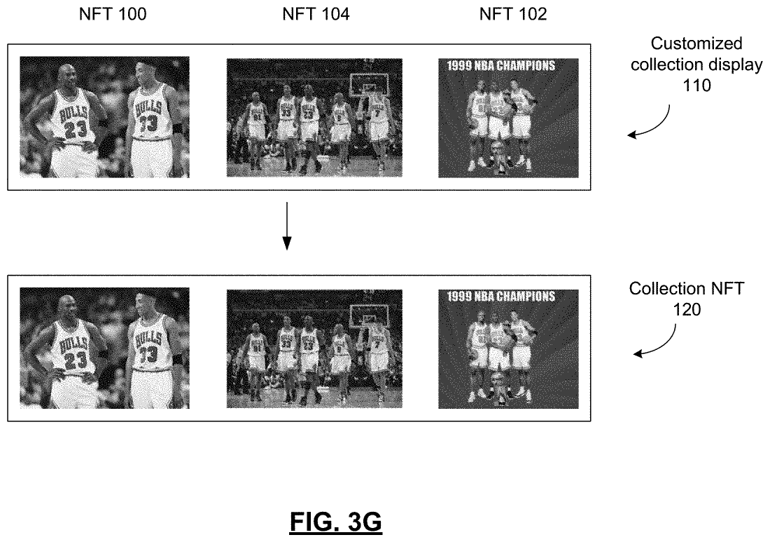

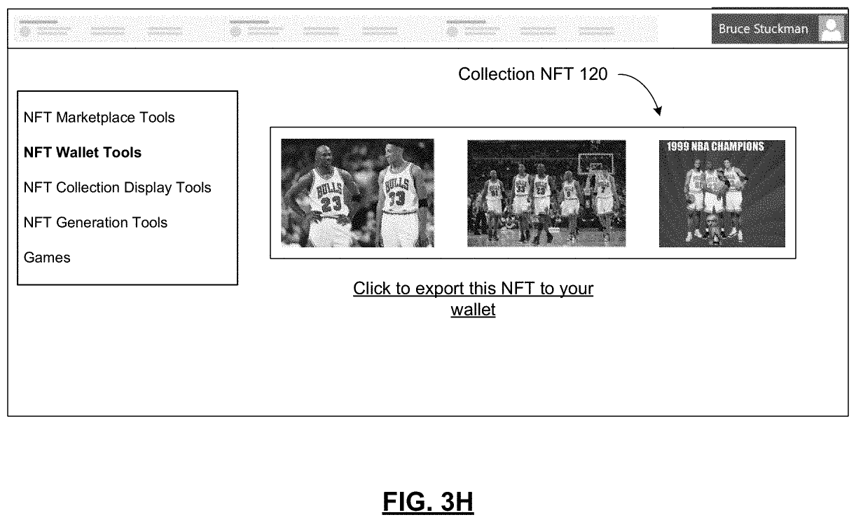

FIG. 3A presents a flowchart representation of an example method in accordance with various examples. In particular, a method 300 for use in conjunction with any of the functions and features described herein for generating a collection NFT based on NFTs in a user's collection.

Step 302 includes importing, via a network interface, a plurality of NFTs associated with the user of the client device. Step 304 includes generating, via a processor and in response to user interactions with the graphical user interface, display data associated with a customized collection display that contains the plurality of NFTs. Step 306 includes sending, via the network interface, the display data associated with the customized collection display via the client device of the user. Step 308 includes facilitating creation of a collection NFT corresponding to the customized collection display that contains the plurality of NFTs.

FIGS. 3B-3F and 3H present pictorial representations of example screen displays. In particular, screen displays of a graphical user interface generated based on display data from the NFT collection platform 800 are shown. In the example below, three NFTs are used to design and create a new collection NFT based on a common theme, the 1999 Chicago Bulls team in the National Basketball association.

In FIG. 3B, the user “Bruce Stuckman” is logged into the NFT collection platform 800. The user has interacted with NFT wallet tools, such as NFT wallet tools 804, to import NFTs 100 and 102 from his wallet residing in NFT wallet system 820. In this example, the NFTs 100 and 102 are blockchain authenticated original photographs depicting two different images of the 1999 Chicago Bulls.

In FIG. 3C, the user has interacted with the NFT marketplace tools, such as NFT marketplace tools 804, to select a new NFT 104 for purchase via an NFT marketplace such as NFT marketplace 822. In FIG. 3D, the wallet tools are used again, this time to export the NFT 104 to the user's wallet. In FIG. 3E, the user has selected and used NFT collection display tools, such as NFT collection display tools 810, to create a customized collection display 110 contain all three 1999 Chicago Bulls-related NFTs he now owns. In the example shown, the user has “dragged and dropped” NFTs he owns in a custom display window and has sized and arranged them into the particular collage that is shown. In other examples, the NFT collection display tools 810 can operate, based on metadata associated with the NFTs of a user indicating content, theme, color themes, subject matter, dates of creation, authorship, ownership, prior ownership, number of prior owners, size, resolution, and other NFT information and metadata, to automatically generate arrangements of custom collection display 110 that may be accepted by the user and/or that may be further arranged by the user to create the final customized collection display 110.

In FIG. 3F, the user has selected NFT generation tools, such as NFT generation tools 808, in order to facilitate, via NFT creation system 824 for example, the creation of a collection NFT from the customized collection display 110.

FIG. 3G presents a flow diagram representation of an example process. In the example shown, the collection NFT 120 is created from the customized collection display 110. As previously discussed, the NFT generation tools can operate by, for example, first authenticating the user's rights in the three NFTs and then creating, via NFT creation system 824, a new NFT of the unique customized image with its own blockchain authentication. In various examples, the collection NFT 120 can contain metadata indicating, for example attributions to the sources of the original NFTs in the collection, the creator of the collection NFT, a date of creation, promotion data and coupons related to offers, privileges and/or discounts, title data with respect to title to tangible or intangible real or personal property, warrant data with respect to tangible or intangible real or personal property, transaction data regarding one or more transactions, and/or other metadata. This metadata can be protected via the blockchain and/or other crypto-based NFT creation technology that is employed to create and protect the collection NFT itself—with or without associated image data. In FIG. 3H, the wallet tools are used again, this time to export the collection NFT 120 to the user's wallet.

FIG. 3I presents a flowchart representation of an example method in accordance with various examples. In particular, a method 310 is presented for use in conjunction with any of the functions and features described herein for generating a collection NFT based on NFTs in a user's collection.

Step 312 includes importing, via a network interface, a plurality of NFTs associated with the user of the client device. Step 314 includes generating, via a processor and in response to metadata associated with the plurality of NFTs, display data associated with a customized collection display that contains the plurality of NFTs. Step 316 includes sending, via the network interface, the display data associated with the customized collection display via the client device of the user. Step 318 includes facilitating creation of a collection NFT corresponding to the customized collection display that contains the plurality of NFTs.

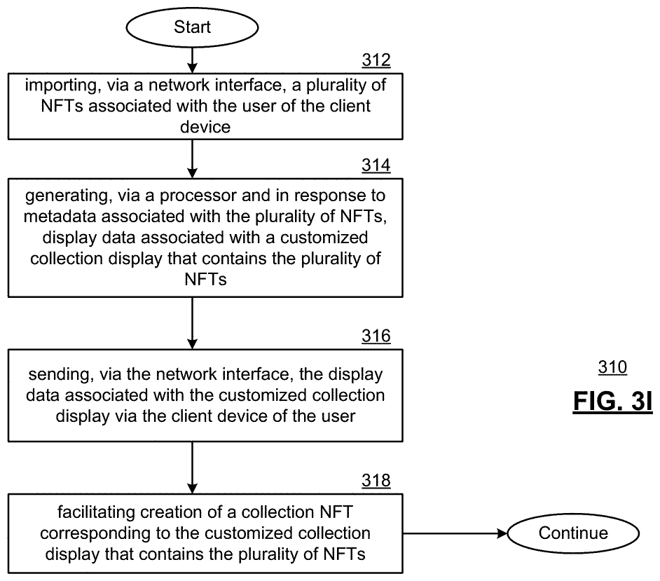

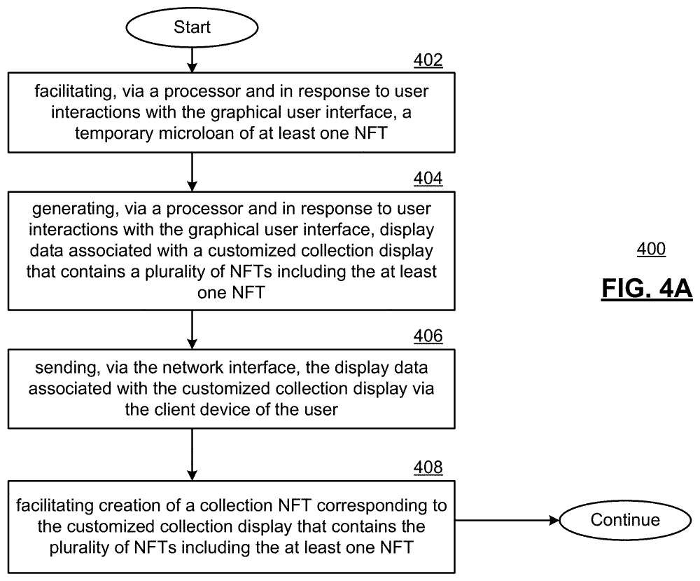

FIG. 4A presents a flowchart representation of an example method. In particular, a method 400 for use in conjunction with any of the functions and features described herein in generating a collection NFT based on at least one NFT accessed via a temporary micro-loan.

Step 402 includes facilitating, via a processor and in response to user interactions with the graphical user interface, a temporary micro-loan of at least one NFT. Step 404 includes generating, via the processor and in response to user interactions with the graphical user interface, display data associated with a customized collection display that contains a plurality of NFTs including the at least one NFT. Step 406 includes sending, via the network interface, the display data associated with the customized collection display via the client device of the user. Step 408 includes facilitating creation of a collection NFT corresponding to the customized collection display that contains the plurality of NFTs including the at least one NFT.

FIG. 4B presents a pictorial representation of an example screen display. In particular, the user has used the marketplace tools to select NFTs 100-1, 102-1, and 104-1. Instead of putting these NFTs up for purchase, the original owners have made them available for temporary micro-loan. This process allows the users can engage to, in exchange for a fee, “borrow” NFTs in order to create a collection NFT. After the Collection NFT is created, or upon the expiration of some predetermined time period (such as 15 minutes, 30 minutes, an hour, a day, etc.) the micro-loaned NFT(s) are returned, expire, deleted or destroyed. Transaction fees apply, a portion of which can be credited to the original NFT owner, the author, including an upfront cost, reward-based payment based on the use and/or performance of the micro-loaned NFT etc. In the alternative, a fixed fee could be charged to the user and credited to the original NFT owner. In various examples, the NFT collection platform 800 may be configured to operate with a single user and/or within a single wallet, and/or to otherwise prohibit the sale or borrowing of micro-loaned NFTs to avoid dilution of the value of the original itself. Furthermore, original and/or derivative NFTs can include restrictions on the total number of micro-loan transactions, the number of simultaneous/contemporaneous micro-loans, restrictions on types of microloan transactions such as normal use loans, staking loans, death match loans, loans less than a predetermined length of time, loans greater than a predetermined length of time, etc.

Consider the following example where an NFT is put up for loan. The proposed loan transaction can include restrictions including an expiration time and/or date, one or N time use in creating a collection NFT or in a game, tournament or challenge, etc. Once the loan is accepted by the borrower, an additional NFT, such as a derivative NFT of the original NFT being loaned, is created on a side chain, layer 1 or 2 blockchain (or “parachain”) that can be different from (and/or independent from) the blockchain used to create the original NFT. This new NFT can be created and transferred to the wallet of the borrower via a smart contract that is based on the restrictions. A cryptocurrency market can be used to fund the transaction and/or to collateralize the micro-loan. The new NFT can then be set via the smart contract to automatically expire (e.g. be deleted from the wallet, destroyed or otherwise disabled), when the restrictions are met. In this fashion, if the purpose of the micro-loan is the creation of a collection NFT, the borrowed NFT can automatically expire once the collection NFT is created. It should be noted that the collection NFT can be created via the same blockchain platform (e.g. Ethereum) used to create the original NFT (e.g. not the parachain).

FIG. 4C presents a flow diagram representation of an example process where a collection NFT 120-1 is generated based on a customized collection display 110-1 created by the user based on the borrowed NFTs 100-1, 102-1 and 104-1. In various examples, the collection NFT 120-1 metadata can also indicate the original sources of the micro-loans as well as the micro-loaned status of NFTs 100-1, 102-1 and 104-1. While not expressly shown, the collection NFTs based on one or more micro-loaned NFTs, can be created with a visual indication of the original vs. micro-loaned status of the NFTs as appropriate.

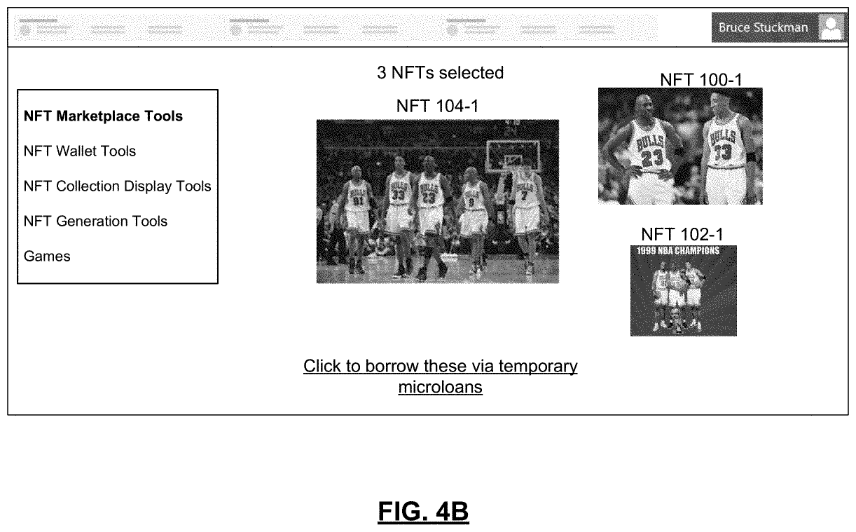

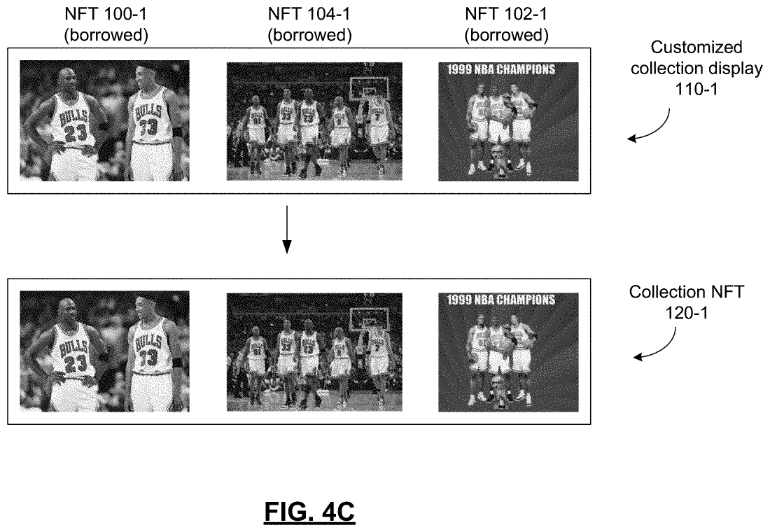

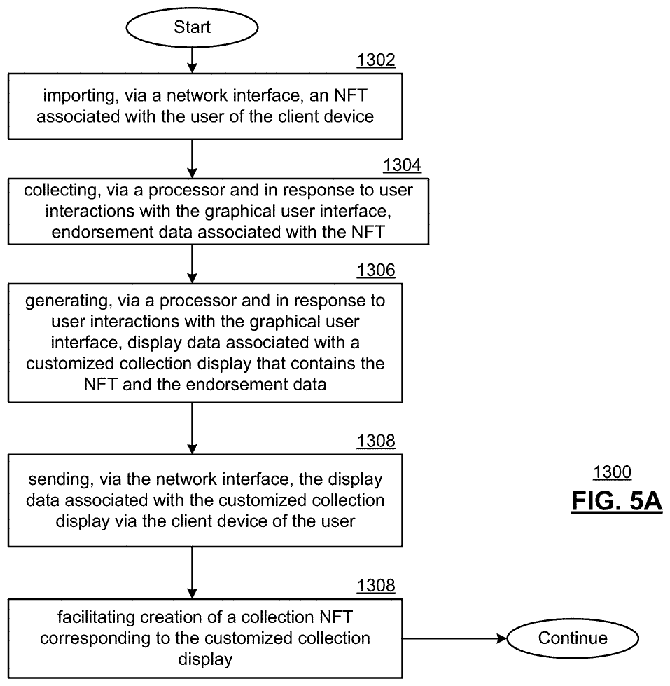

FIG. 5A presents a flowchart representation of an example method. In particular, a method 1300 for use in conjunction with any of the functions and features previously described facilitates the collection of endorsements associated with an NFT. Step 1302 includes importing, via a network interface, an NFT associated with the user of the client device. Step 1304 includes collecting, via a processor and in response to user interactions with the graphical user interface, endorsement data associated with the NFT. Step 1306 includes generating, via the processor and in response to user interactions with the graphical user interface, display data associated with a customized collection display that contains the NFT and the endorsement data. Step 1308 includes sending, via the network interface, the display data associated with the customized collection display via the client device of the user. Step 1310 includes facilitating creation of a collection NFT corresponding to the customized collection display.

FIGS. 5B and 5C present pictorial representations of example screen displays. In FIG. 5B, the user is interacting with the graphical user interface to use the NFT marketplace tools to seek an endorsement for a selected NFT. After an endorsement in the form of a signature has been received it can be appended to the customized collection display of the NFT. In FIG. 5C, the user interacts with the NFT generation tools to generate a collection NFT that includes both the NFT and the signature. In various examples, this collection NFT 120-6 metadata can also indicate an attribution associated the endorsement itself. Furthermore, the endorsement itself can be an original NFT, a derivative NFT, a micro-loaned NFT or other NFT.

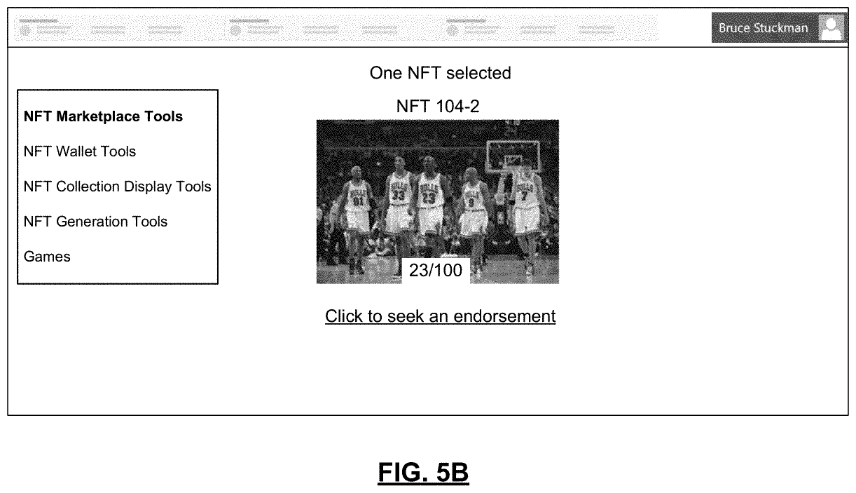

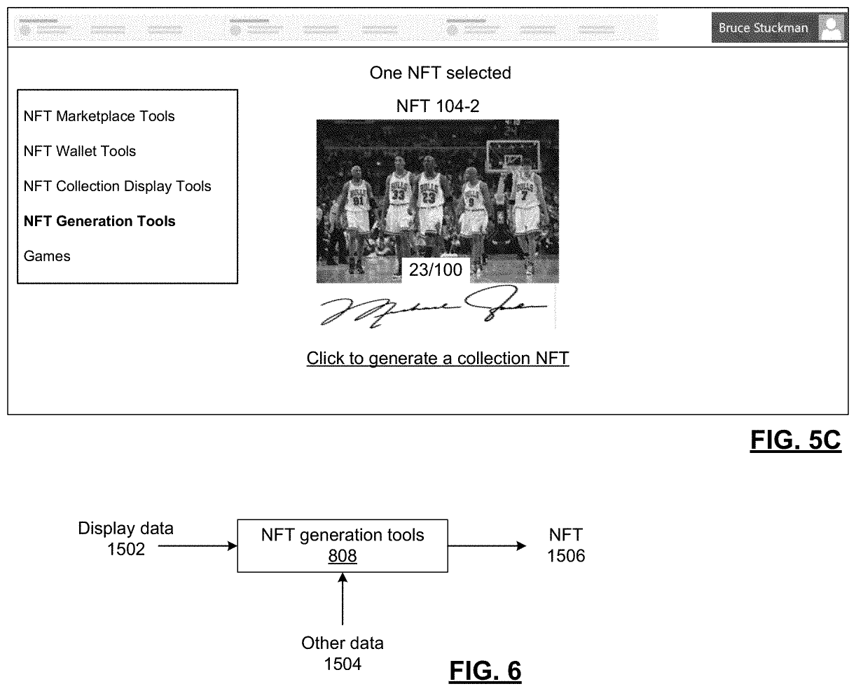

FIG. 6 presents a block diagram/flow representation of an example of NFT generation. In the example shown, NFT generation tools 808 operate to convert display data 1502 and other data 1504 into an NFT 1506. The display data 1502 can correspond to an original NFT, borrowed (e.g. temporary micro-loaned) NFT, a derivative NFT, a customized collection display 110, an original image, and/or other derivatives or micro-loans thereof or other display or image data. In various examples, the NFT generation tools 808 can operate to verify the credentials of any NFTs whose images are contained in the display data 1502, prior to creating the NFT 1506. In this fashion, derivative NFTs can only be created when the source NFT or NFTs are verified—preventing the creation of unauthorized or counterfeit NFTs.

The other data 1504, can be image data including signatures and other endorsement images, visual indications of derivative series, originality classification, attributions, or other image data, metadata of all kinds including metadata indicating one or more originality classifications, attributions, endorsement data, other derivative data indicating the series number and total number in a derivative series, restrictions on micro-loans or other derivatives, restrictions on derivatives with artistic effects, restrictions that derivatives must include attributions to the original source, restrictions on numbers of derivatives or micro-loans or the sizes of derivative series, restrictions on the creation of collection NFTs, the number of collection NFTs, the creation of collection NFTs including NFTs from other sources, from prohibited sources or with prohibited content, geographical restrictions, time restrictions (e.g., can be used to create derivatives or collection NFTs or can be temporarily micro-loaned for 1 month, one year, etc., other restrictions and/or other data associated with, or to be associated with, the display data 1502.

This other data 1504 can be used to generate an NFT and/or combined with the display data 1502 to create a dataset that includes both the display data 1502 and the other data 1504. This other data 1504 or combined dataset can be protected via the blockchain and/or other crypto-based NFT creation technology that is employed by the NFT generation tools 808 and via the NFT creation system 824 to create and protect the new NFT 1506 itself. It should be noted that the NFT 1506 can include a single derivative or a number of derivatives, including a limited series of derivatives. It should be noted further that some or all of the other data 1504, including restriction data and/or attribution data, can be derived from one or more original NFTs whose images are associated with the display data 1502. Furthermore, some or all of the other data 1504 can be generated in response to user interactions with a graphical user interface generated in conjunction with the NFT collection platform 800.

FIG. 7 presents a block diagram representation of an example system. In particular, a system 2850 is presented that includes an NFT distribution platform 2800 that communicates with client devices 825 via a network 115. The network 115 can be the Internet or other wide area or local area network, either public or private. The client devices 825 can be computing devices associated with users, for example, buyers, sellers, collectors, game players and/or other users of NFTs.

In the example shown, the NFT distribution platform 2800 includes a client device interface 2802 for interacting with the client devices 825, NFTs 2804 to be distributed, and an operating system 2844. One or more of the NFTs 2804 can have geographical restrictions as to distribution that are either part of the NFTs themselves or have restriction data that is stored separately.

The NFT distribution platform 2800 includes a network interface 2820 such as a 3G, 4G, 5G or another cellular wireless transceiver, a Bluetooth transceiver, a WiFi transceiver, UltraWideBand transceiver, WIMAX transceiver, ZigBee transceiver or other wireless interface, a Universal Serial Bus (USB) interface, an IEEE 1394 Firewire interface, an Ethernet interface or other wired interface and/or other network card or modem for communicating for communicating via the network 115.

The NFT distribution platform 2800 also includes a processing module 2830 and memory module 2840 that stores an operating system (O/S) 2844 such as an Apple, Unix, Linux or Microsoft operating system or another operating system, the client device interface 2802, and the NFTs 2804. The O/S 2844 and the client device interface 802 each include operational instructions that, when executed by the processing module 830, cooperate to configure the processing module 830 into a special purpose device to perform the particular functions of the NFT distribution platform 2800 described herein.

The NFT distribution platform 2800 may include a user interface (I/F) 2862 such as a display device, touch screen, key pad, touch pad, joy stick, thumb wheel, a mouse, one or more buttons, a speaker, a microphone, an accelerometer, gyroscope or other motion or position sensor, video camera or other interface devices that provide information to an administrator of the NFT distribution platform 2800 and that generate data in response to the administrator's interaction with NFT distribution platform 2800.

The processing module 2830 can be implemented via a single processing device or a plurality of processing devices. Such processing devices can include a microprocessor, micro-controller, digital signal processor, microcomputer, central processing unit, quantum computing device, field programmable gate array, programmable logic device, state machine, logic circuitry, analog circuitry, digital circuitry, and/or any device that manipulates signals (analog and/or digital) based on operational instructions that are stored in a memory, such as memory 2840. The memory module 2840 can include a hard disc drive or other disc drive, read-only memory, random access memory, volatile memory, non-volatile memory, static memory, dynamic memory, flash memory, cache memory, and/or any device that stores digital information. Note that when the processing device implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. While a particular bus architecture is presented that includes a single bus 2860, other architectures are possible including additional data buses and/or direct connectivity between one or more elements. Further, the NFT distribution platform 2800 can include one or more additional elements that are not specifically shown.

For example, the client device interface 2802 can operate in conjunction with each client device 825 and via network 115 to generate a graphical user interface. This graphical user interface is based on display data generated by the NFT distribution platform 2800 in a format for display on a display device associated with the client devices 825. This graphical user interface generates input data that is received by the NFT distribution platform 2800 from the client devices 825 in response to user interaction with the graphical user interface.

In various examples, the NFT distribution platform 2800 can operate to respond to input data from client devices in the form of read requests for NFTs and geolocation data such as GPS coordinates, connection to or proximity with a network element of network 115 or other location data indicating a location of the client device 825. The NFT distribution platform 2800 sends the requested NFT(s) to the requesting client device—only when the geolocation data conforms with restriction data—for example, when the geolocation data indicates a position of the requesting client device within a limited area or proximity indicated by the restriction data.

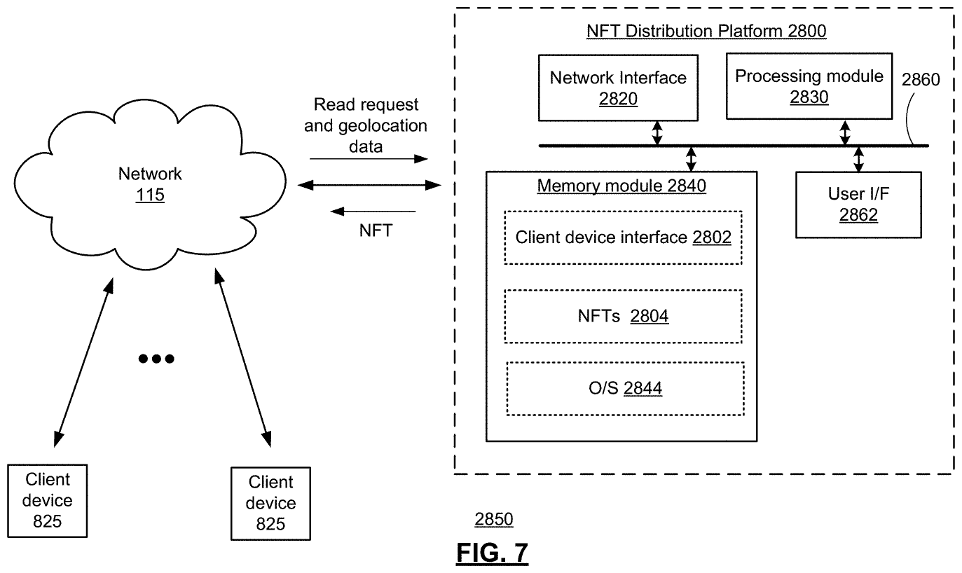

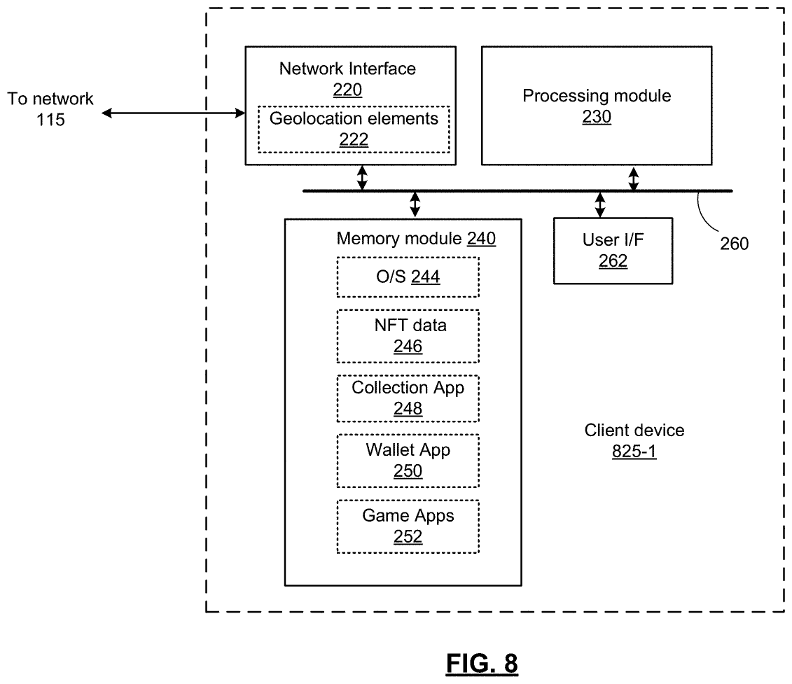

FIG. 8 presents a block diagram representation of an example client device. In particular, a client device 825-1 is presented that functions similarly to client device 825, and includes several elements of client device 825 that are referred to by common reference numerals. The client device 825-1 is capable of operating to client device 825 described herein.

In addition, the memory module 240 includes a wallet application (app) 250 that is capable of engaging in financial transactions including credit card transactions and traditional digital payments, is capable of holding crypto-currency and engaging in crypto-currency transactions and is further capable of storing one or more NFTs that are either original NFTs, derivative NFTs, borrowed (temporarily micro-loaned) NFTs, collection NFTs and/or combinations thereof. In various examples, the wallet app 250 is capable of operating in conjunction with the NFT collection platform 800, the NFT distribution platform 2800, the NFT wallet system 820, the NFT marketplace 822, and/or the NFT creation system 824 via network 115.

As will be understood by one skilled in the art, unlike a normal wallet, which can physically hold cash, credit cards, etc., NFT wallets “store” NFTs by storing the NFT data necessary to access the NFT. So, even though a wallet can be said to store an NFT, technically the NFT content is stored on the blockchain, which can only be accessed via the NFT data in the wallet. This NFT data includes metadata, other off-chain data corresponding to the NFT and in particular, a private key. This private key can be considered an indicator of ownership of the NFT and is required to access the NFT via the blockchain. If the NFT data (including the private key) is lost, the NFT can no longer be accessed—and the NFT is itself “lost” for all intents and purposes, even though it remains immutably stored on the blockchain.

Also, the memory module 240 includes one or more game apps 252 that represent either stand alone games of the client device 825-1 or that operate in conjunction with the games 812 of the NFT collection platform 800 and/or interface with the NFT distribution platform 2800. This allows, for example, a user of client device 825-1 to engage in (e.g. play) games associated with NFT content, and engage in other activities that involve the acquisition, collection, display, distribution, and/or use of one or more NFTs that are either original NFTs, derivative NFTs, borrowed (temporarily micro-loaned) NFTs, collection NFTs and/or combinations thereof.

Furthermore, the network interface 220 includes one more geolocations elements 222 such as a GPS receiver, a ultra-wideband (UWB) transceiver, a Bluetooth transceiver and/or other component(s) that that facilitate the generation of geolocation data and/or facilitate other location-based services. Consider the case where the client device 825 is a smartphone or tablet and the wallet app 250 is an Apple or Android wallet or mobile wallet card that is in a Apple or Android wallet. Once the wallet app 250 is activated, NFTs can be easily added to the wallet. In addition, the wallet app 250 can access the location services of the device, and for example, generate push notifications regarding NFTs that are available near the current location.

In various examples, the geolocation data generating in such a fashion can facilitate the generation of geolocation data discussed in conjunction with the operation of NFT distribution platform 2800. In particular, the NFT distribution platform 2800 can automatically detect the presence of the user at a venue based on geolocation data received from the user's client device 825-1 and automatically prompted the user to click to send a read request. In this fashion, the user can be geo-authorized, before the request. In other examples, the NFT distribution platform 2800 can distribute NFTs to client devices 825 based on payments, authentication and/or other criteria that does not rely on geolocation data.

Furthermore, while the client device 825-1 and NFT collection platform 800 (or NFT distribution platform) are shown as separate devices that communicate via the network 115, it should be noted that any and all of the functionality attributed to the NFT collection platform 800 (or NFT distribution platform), including the NFT marketplace tools 804, NFT wallet tools 806, NFT generation tools 808, NFT collection display tools 810, games 812, and database 814, etc. can likewise be incorporate directly into the client device 825. In this fashion, a client device 825 through the application of its operating system 244 and one or more applications can provide a graphical user interface to operate via network 115 but independently from any NFT collection platform to perform any of the functions and features described herein. In particular, the client device 825 can perform the functions of both the client device and the NFT collection platform 800 without requiring communications to be sent to the client device 825 from a NFT collection platform (or NFT distribution platform) and communications sent to a NFT collection platform (or NFT distribution platform) from the client device 825.

In addition, NFT generation tools 808 can be used to protect, encrypt and/or authenticate any digital information that could be stored in the wallet app 250, including for example rewards cards, coupons, movie tickets, event tickets, boarding passes, public transit cards, student ID cards, credit cards, debit cards, prepaid cards, and loyalty cards. In addition, the functionality of the wallet app 250 can be further expanded to protect other information such as vehicle titles, warranty cards, driver's licenses and other IDs, vaccination records, prescriptions, and/or other medical records, social security cards, financial records, authentication tokens, insurance cards, passwords, user IDs and/or other images and information of a personal and/or sensitive nature. Any of these types of digital information can be protected via an NFT or other blockchain transaction in conjunction, with or without associated image or display data, and with or without metadata and/or “other data” as that term has been used herein in association with the NFT generation tools 808.

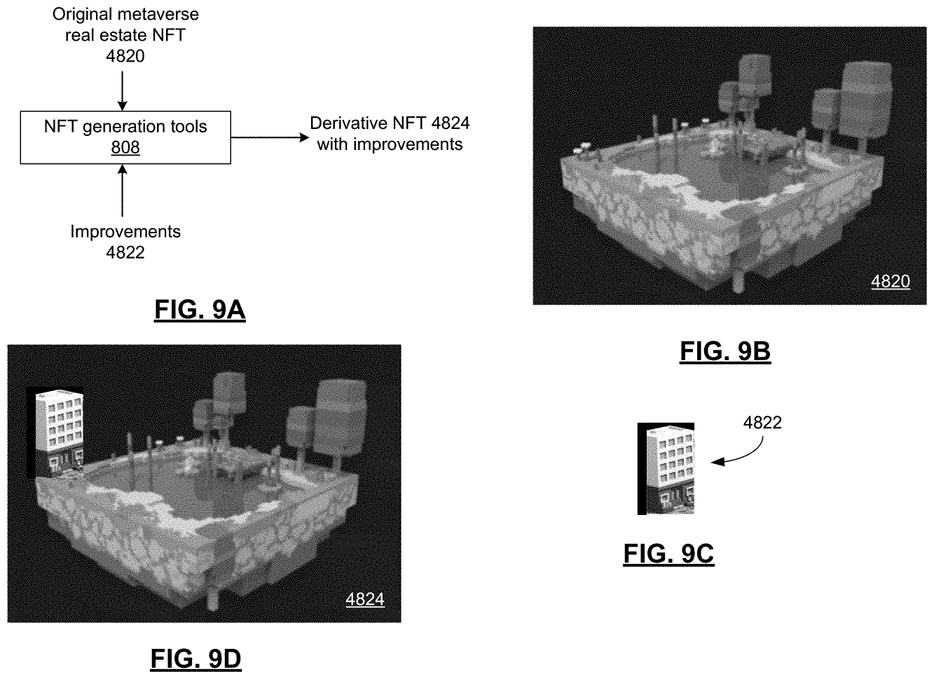

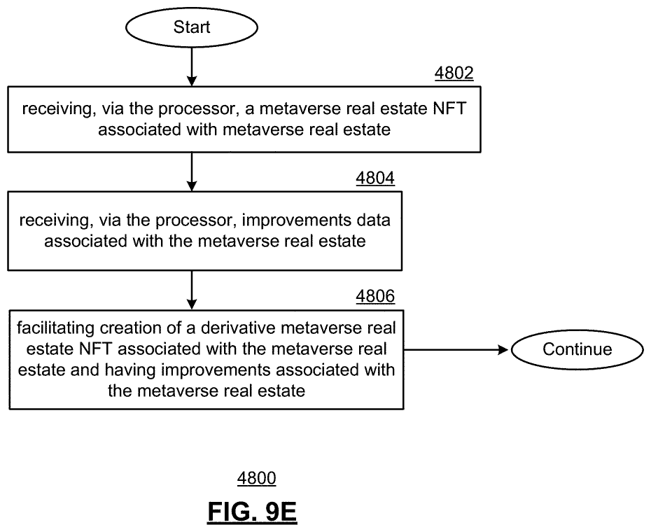

FIG. 9A presents a block diagram/flow representation of an example of NFT generation. In the example shown, an original metaverse real estate NFT 4820 corresponds to a portion/plot of real estate that is used in a game or metaverse application. An example is shown in FIG. 9B. The original metaverse real estate NFT 4820 can be purchased by the user, created or leveled-up via game play or otherwise acquired by the user of a metaverse application or game.

The NFT generation tools 808 are used to generate a derivative NFT 4824 or other metaverse real estate NFT that is based on the improvements 4822 shown in FIG. 9C. In the example shown the improvements 4822 correspond to a building or other structure, however, other real estate improvements can likewise be implemented. In various example, the derivative NFT 4824 with improvements shown in FIG. 9D can be created on a parachain or other sidechain that is different from the blockchain on which the original metaverse real estate NFT 4820 resides or the same blockchain on which the original metaverse real estate NFT 4820 resides.

FIG. 9E presents a flowchart representation of an example method. In particular, a method 4800 is presented for use in conjunction with any of the functions and features described herein. Step 4802 includes receiving, via the processor, a metaverse real estate NFT associated with metaverse real estate. Step 4804 includes receiving, via the processor, improvements data associated with the metaverse real estate. Step 4806 includes facilitating creation of a derivative NFT associated with the metaverse real estate and having improvements associated with metaverse real estate.

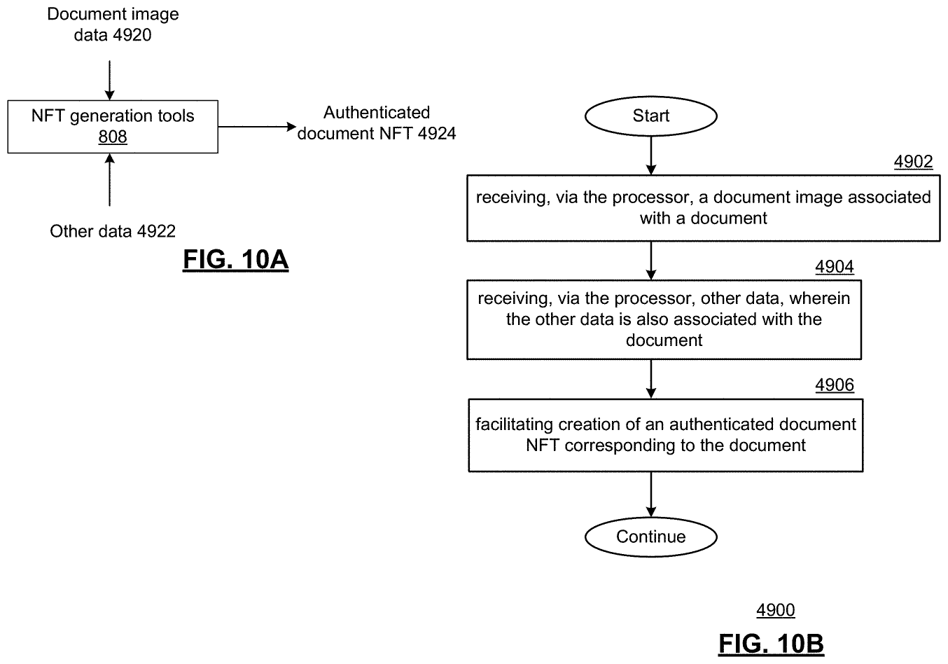

FIG. 10A presents a block diagram/flow representation of an example of NFT generation. In the example shown, document image data 4920 and other data corresponding to a document are used to generate an authenticated document NFT 4924 via the NFT generation tools 808. These authenticated document NFTs 4924 can be stored in an NFT wallet associated with the mobile phone or other client device associated with the user and can be used, for example, in place of coupons, cards, legal documents, medical documents, financial documents, IDs, credit cards, licenses and/or other important documents associated with a user that normally exist in non-digital, e.g. paper or plastic form. The authenticated document NFT 4924 can be used to prevent fraud and/or promote privacy in transactions via secure user and/or document authentication. In various examples, the authenticated document NFT 4924 can be presented and analyzed via secured blockchain or other crypto transactions at the time of a transaction in order to authenticate the identity of the user and/or to verify the accuracy and authentic nature of the other data 4922 and/or to facilitate the security of the transaction.

FIG. 10B presents a flowchart representation of an example method. In particular, a method 4900 is presented for use in conjunction with any of the functions and features described herein. Step 4902 includes receiving, via the processor, a document image associated with a document. Step 4904 includes receiving, via the processor, other data, wherein the other data is also associated with the document. Step 4906 includes facilitating creation of an authenticated document NFT corresponding to the document.

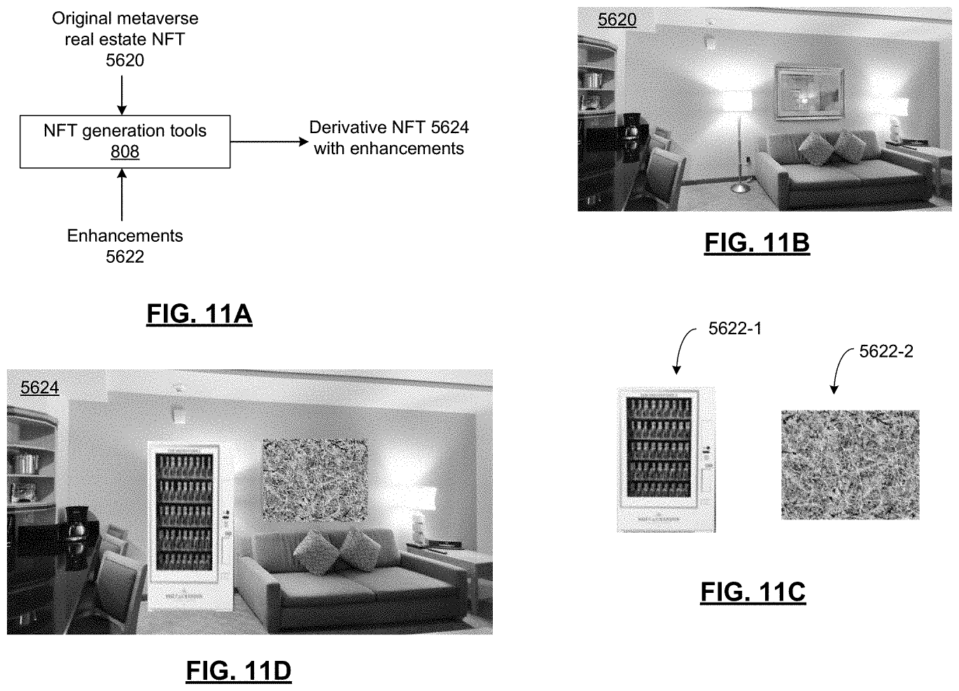

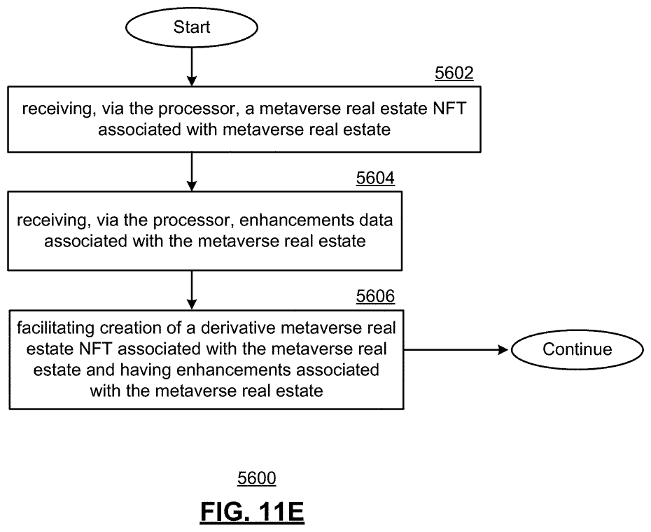

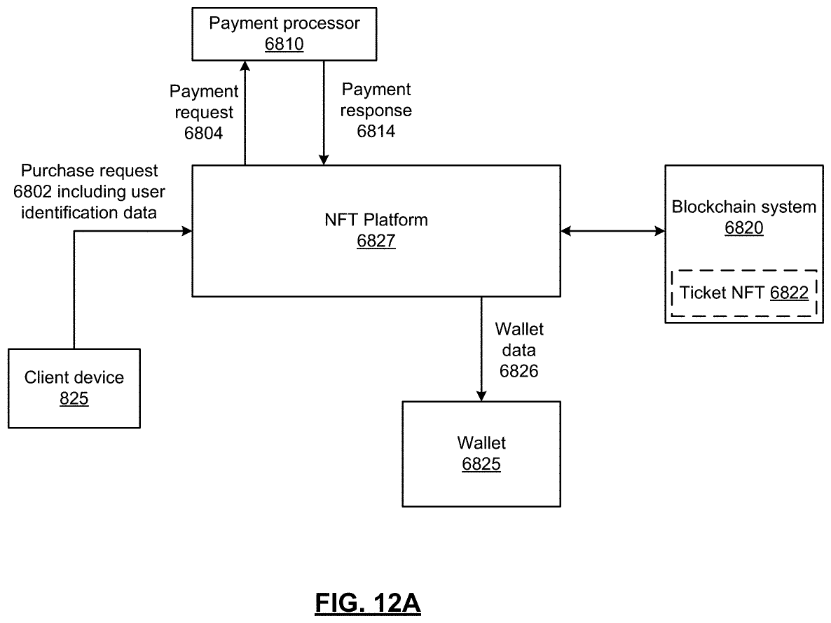

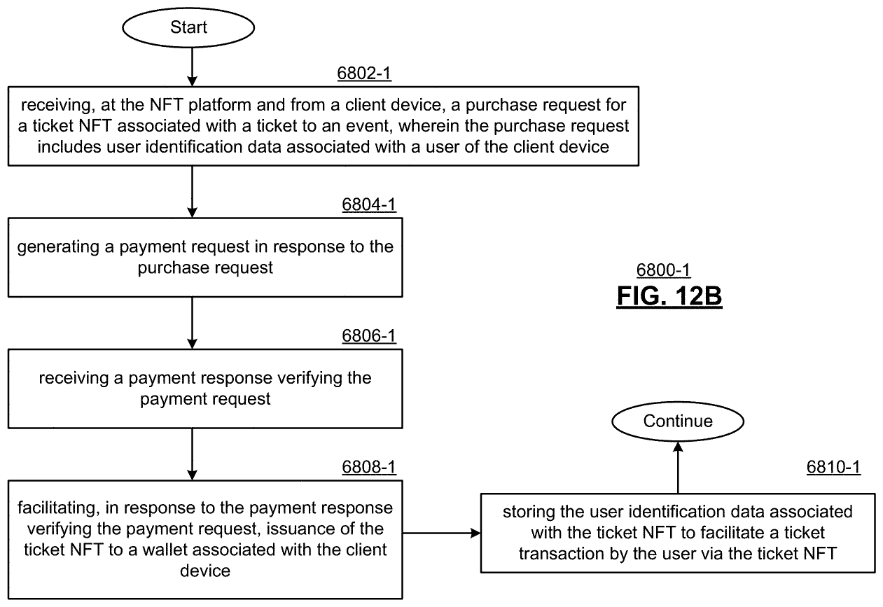

FIG. 11A presents a block diagram/flow representation of an example of NFT generation. The NFT generation tools 808 are used to generate a derivative NFT 5624 based on an original metaverse real estate NFT 5620 and based on the enhancement data 5622.

In the example shown in FIG. 11B, an original metaverse real estate NFT 5620 corresponds to real estate having an interior room that is used in a game or metaverse application. The original metaverse real estate NFT 5620 can be purchased by the user, created or leveled-up via game play or otherwise acquired by the user of a metaverse application or game.

The NFT generation tools 808 are used to generate a derivative NFT 5624 or other metaverse real estate NFT that is based on the enhancements data 5622 shown in FIG. 11C. In the example shown the enhancements 5622-1 and 5622-2 correspond to a Moet & Chandon vending machine and a Jackson Pollock painting that are acquired either as image data or as individual NFTs. While particular enhancements are shown, other real estate enhancements can likewise be implemented including statues and other art, rugs, lamps, furniture and other furnishings and accessories, outdoor objects, appliances, knick-knacks, machinery and other virtual objects for decorating or finishing an office, home, factory, venue or other real estate.

In the example shown in FIG. 11D, the user has placed the enhancements 5622-1 and 5622-2 as desired before creating the derivative NFT 5624. The derivative NFT 5624 with improvements shown can be created on a parachain or other sidechain that is different from the blockchain on which the original metaverse real estate NFT 5620 resides or the same blockchain on which the original metaverse real estate NFT 5620 resides.

FIG. 11E presents a flowchart representation of an example method. In particular, a method 5600 is presented for use in conjunction with any of the functions and features described herein. Step S602 includes receiving, via the processor, a metaverse real estate NFT associated with metaverse real estate. Step S604 includes receiving, via the processor, enhancement data associated with the metaverse real estate. Step S606 includes facilitating creation of a derivative NFT associated with the metaverse real estate and having enhancements associated with metaverse real estate.

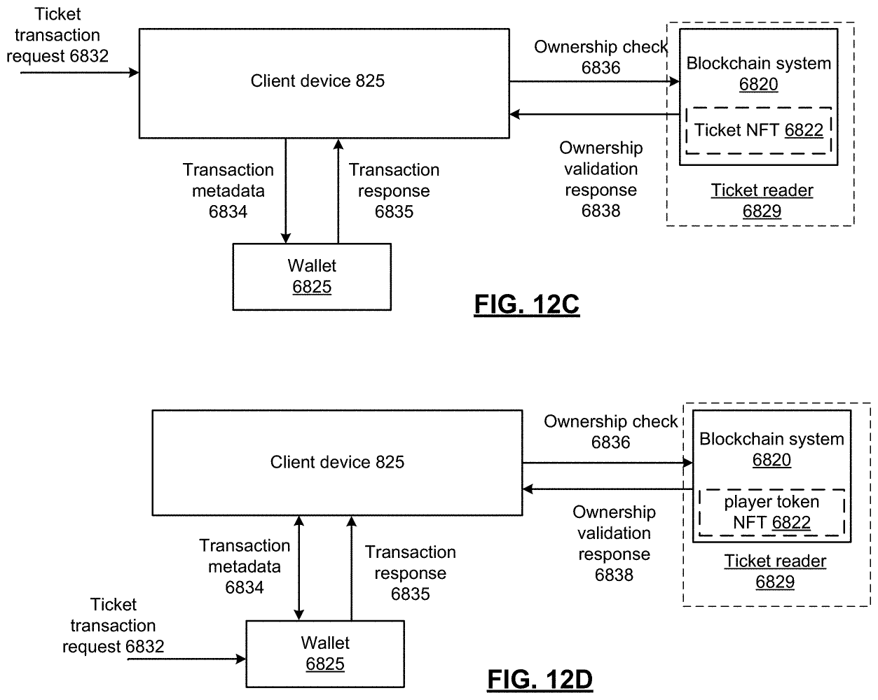

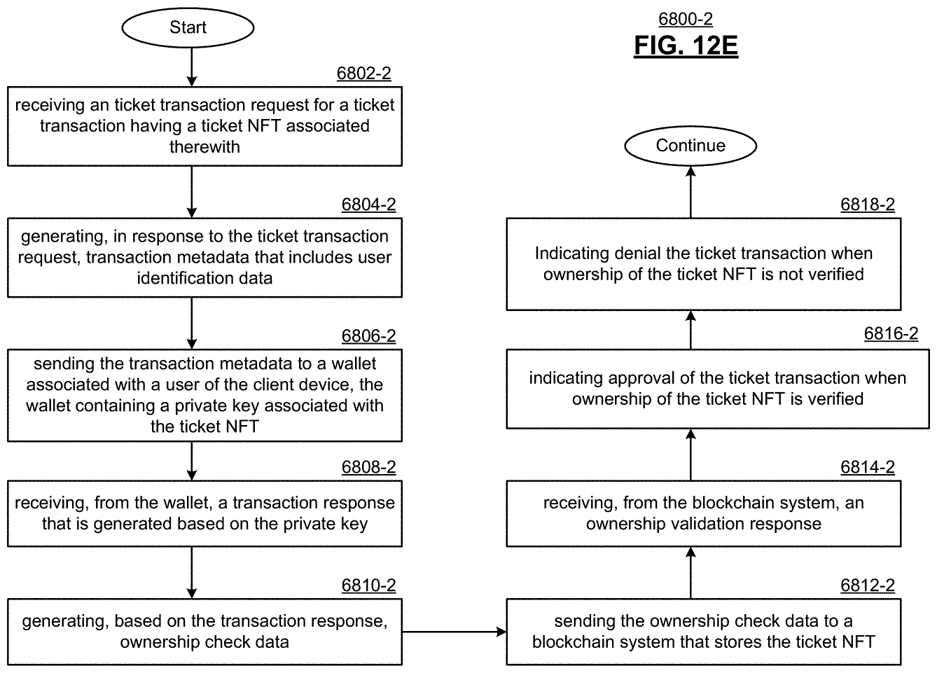

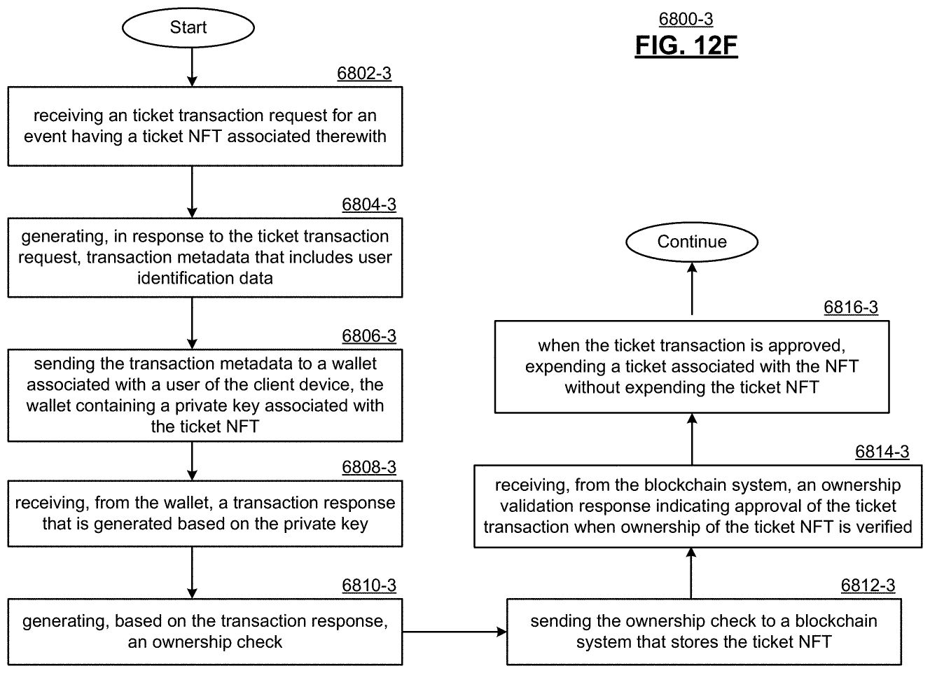

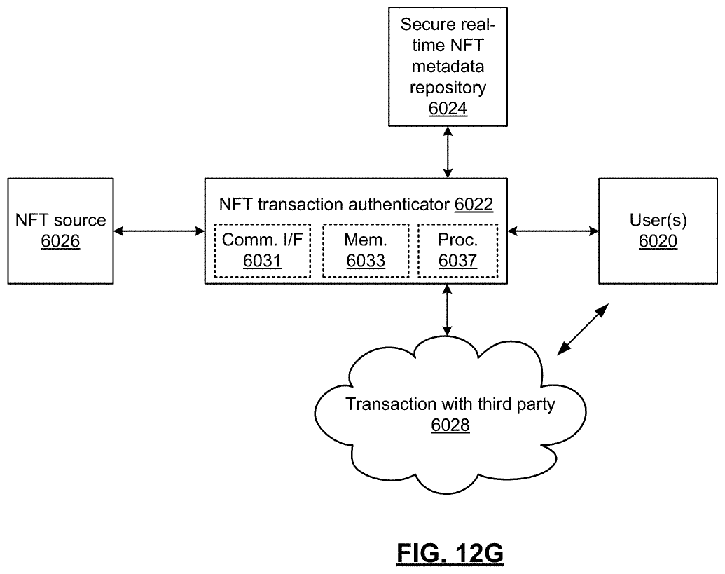

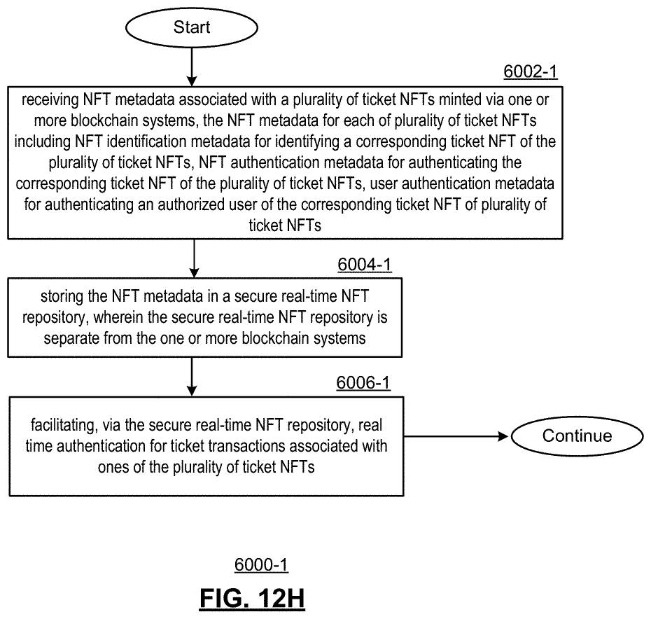

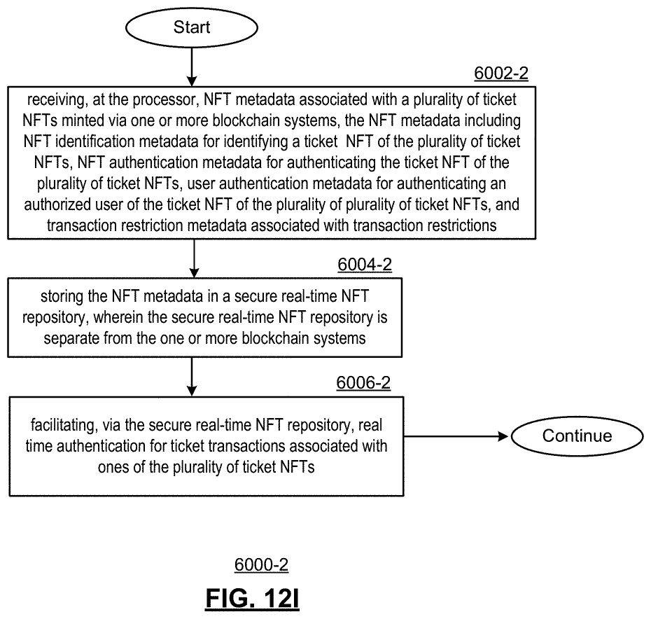

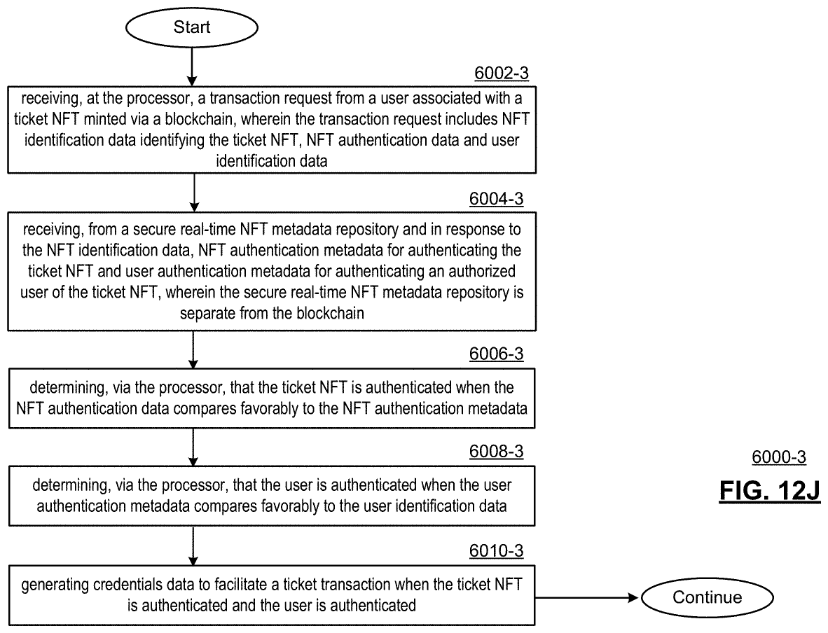

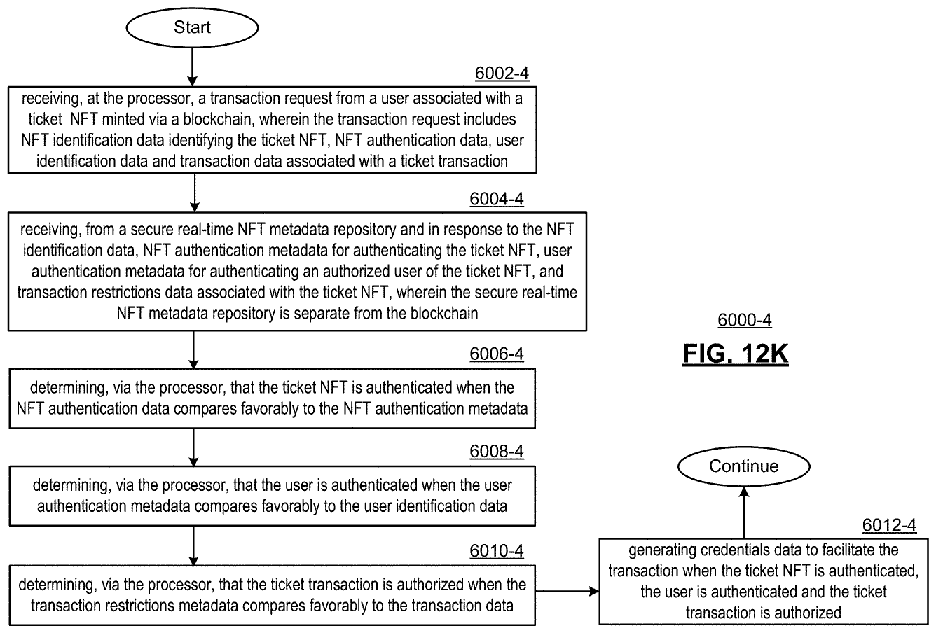

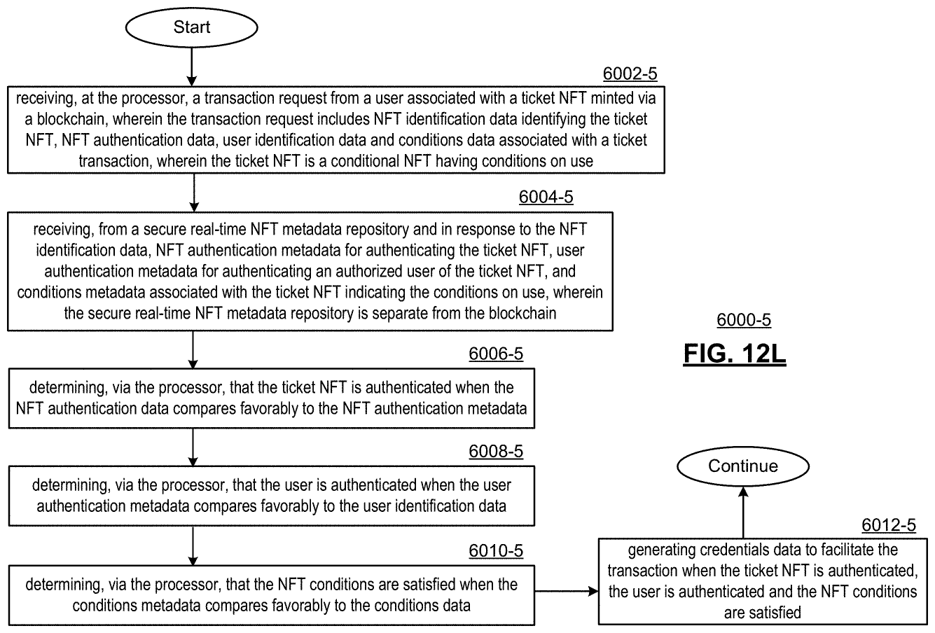

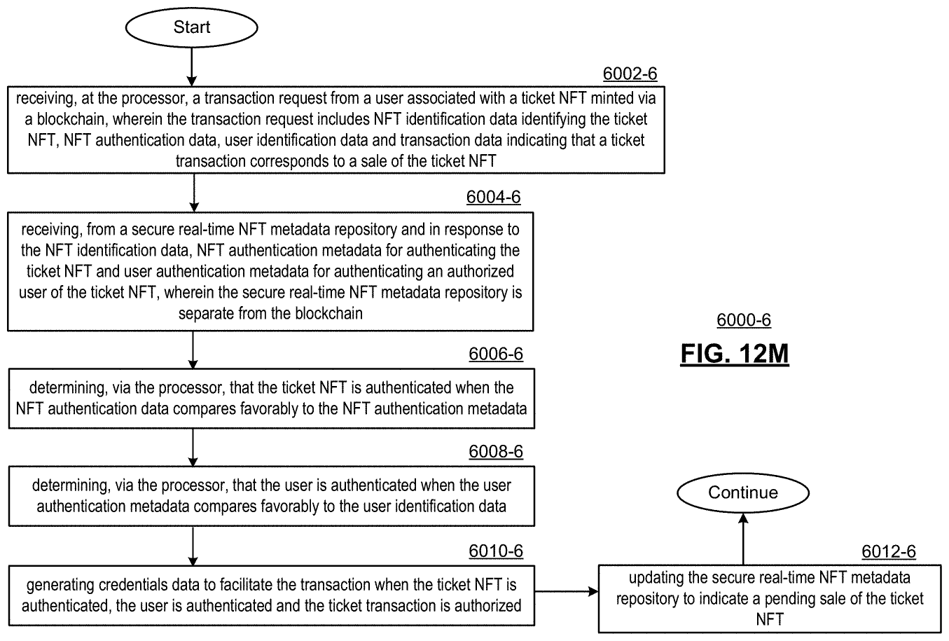

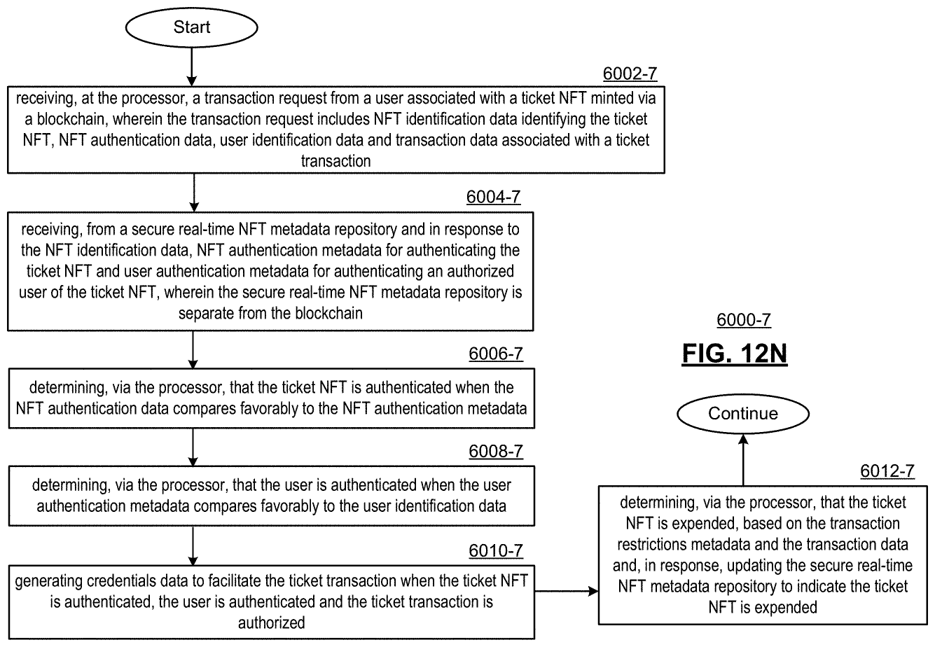

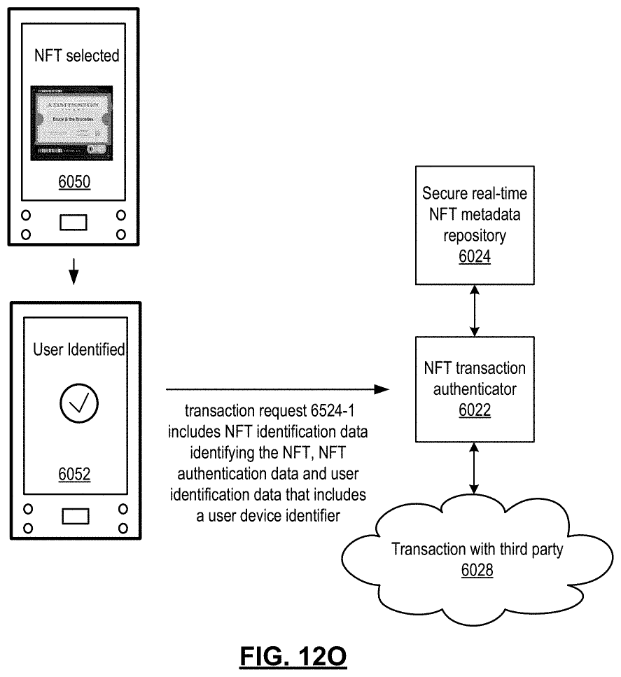

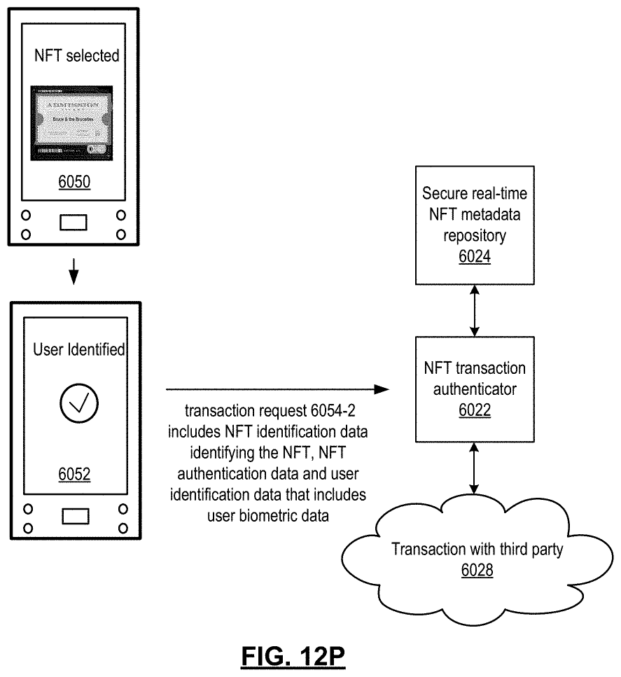

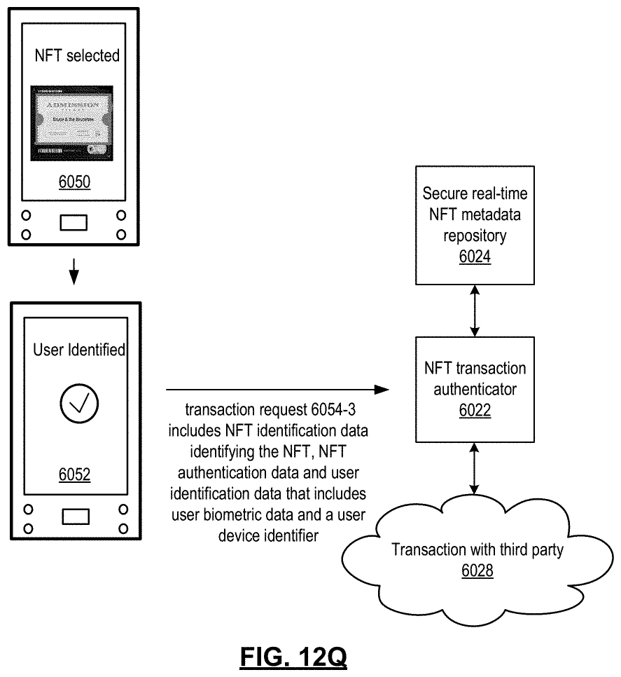

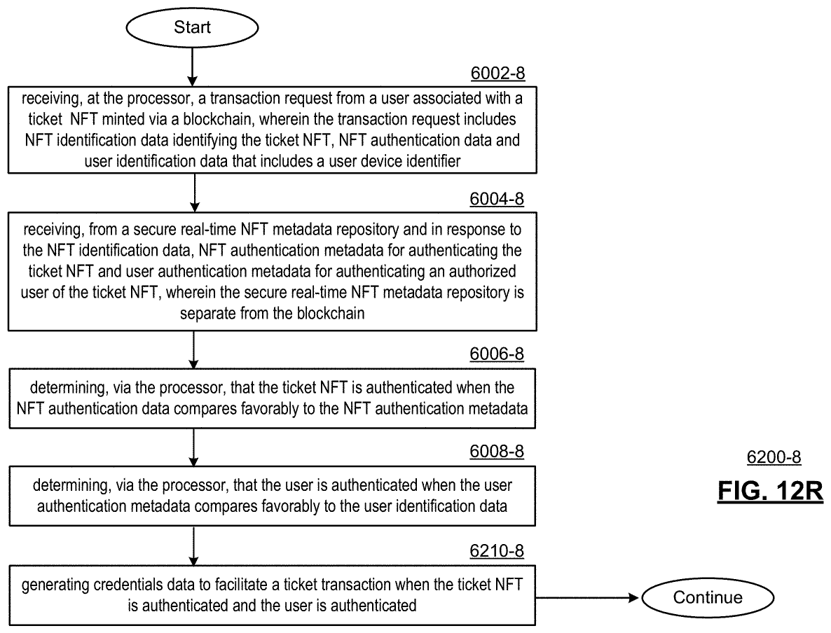

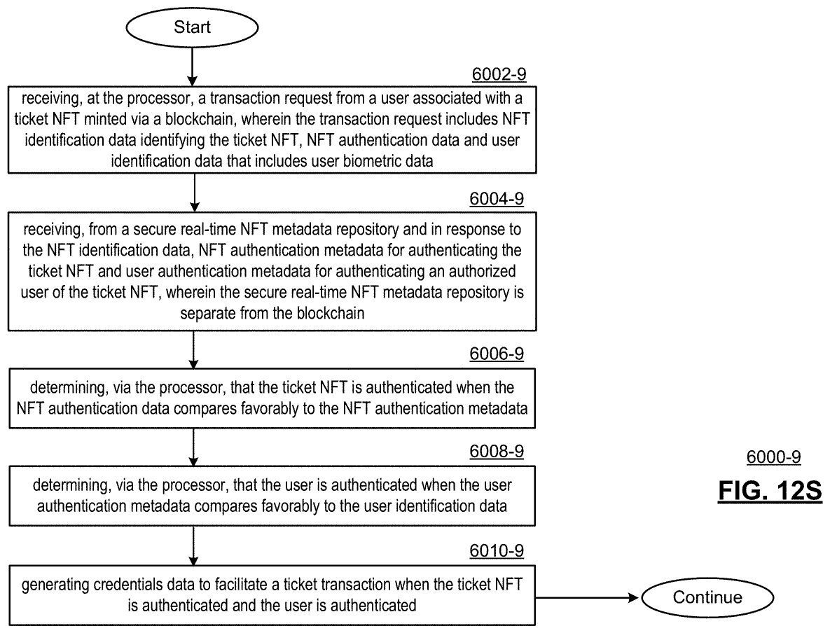

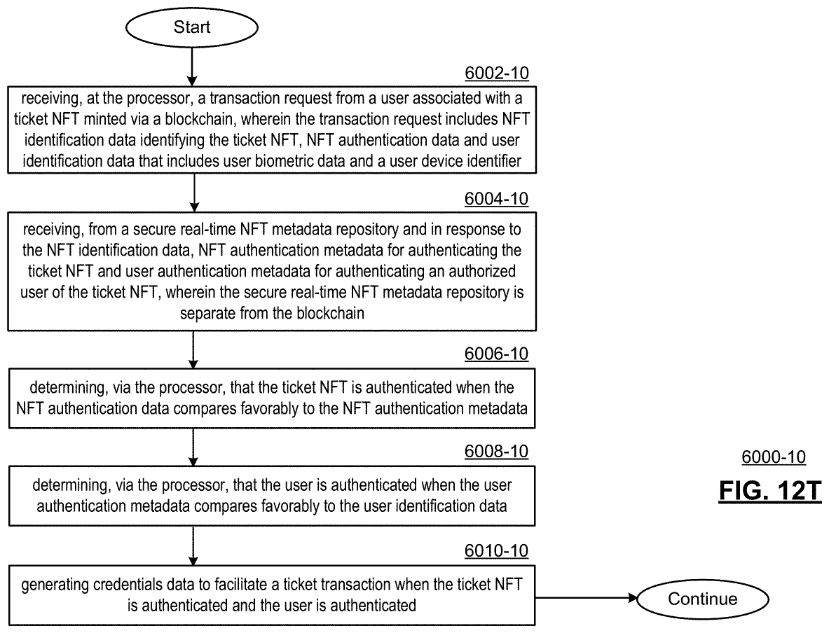

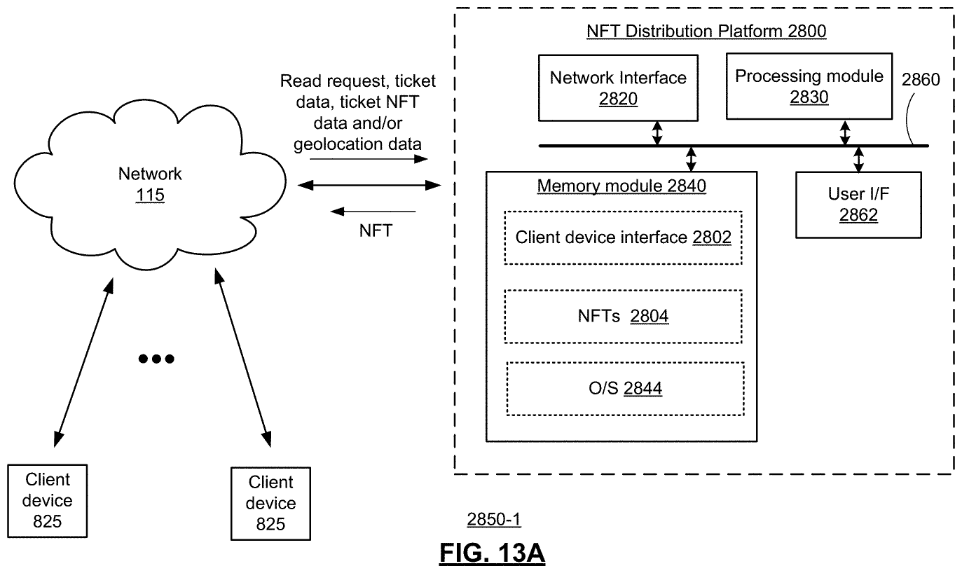

FIG. 12A presents a block diagram representation of an example system. The system includes a NFT platform 6827 such as NFT collection platform 800, NFT distribution platform 2800 or other NFT platform that operates to facilitate the creation of new NFTs such as ticket NFTs or other NFTs associated with tickets including badges and/or passes associated with sports stadiums and events, concerts and other music venues and events, and/or other venues or events. The system further includes a client device 825, a payment processor 6810 or other marketplace or marketplace tool, a blockchain system 6820, such as NFT creation system 824 or other decentralized computer system and a wallet 6825, such as NFT wallet system 820, a wallet application associated with client device 825 or other electronic wallet.

A client device generates a purchase request 6802 for a ticket NFT 6822 associated with an event/venue that is received by the NFT platform 6827. The NFT platform 6827 responds by generating a payment request 6804 and receives a payment response 6814 indicating whether or not the payment request is verified. In various examples, in response to the payment response verifying the payment request, the NFT platform system 6827 facilitates the minting of a ticket NFT 6822 associated with a ticket to the event/venue. In the alternative, one or more ticket NFTs can be minted prior to sale. In this fashion, for example, a limited, numbered series and/or other set of ticket NFTs can be minted and offered for sale to potential attendees as special collector's items. In a further example, ticket NFTs can be minted with special subsidiary benefits not associated with an ordinary ticket, such as a backstage pass, premium access, a meet and greet component, etc. In yet another example, ticket NFTs can be generated for all of the tickets to an event. Pre-minting a number of NFTs for sale can help expedite the sales because the minting of the ticket NFTs does not need to occur in real-time. This can pre-minting can be performed in batches as tickets from previous batches are sold.

In various examples, minting of the ticket NFT 6822 includes generation of a private key associated with the ticket NFT that is stored with NFT metadata and/or other wallet data 6826 in the wallet 6825. In other examples, an existing private key from the wallet 6825 or other existing private key can be retrieved and used for the same purpose. The ticket NFT 6822 serves to authenticate ticket and/or validate the user of the client device 825 and associated wallet 6825 as the owner of the ticket in a ticket transaction where the ticket NFT is used to gain access to the associated event/venue, for example, by verification of the ticket NFT via the client device 825 in conjunction with a reader at the event/venue. This improves the technology of ticket systems by providing a secure and incorruptible methodology for authenticating event/venue access and/or authenticating the user to the event/venue as the actual ticket holder. While a particular architecture is shown, other configurations, combinations and connections are likewise possible. For example, while the wallet 6825 is shown separately from the client device 825, the wallet can be implemented as an application, such as wallet app 250 of the client device 825 as previously discussed.

FIG. 12B presents a flowchart representation 6800-1 of an example method. In particular, a method is presented for use in conjunction with one or more functions or features described herein. Step 6802-1 includes receiving, at an NFT platform and from a client device, a purchase request for a ticket NFT associated with a ticket to an event, wherein the purchase request includes user identification data associated with a user of the client device. Step 6804-1 includes generating a payment request in response to the purchase request. Step 6806-1 includes receiving a payment response verifying the payment request. Step 6808-1 includes facilitating, in response to the payment response verifying the payment request, issuance of a ticket NFT to a wallet associated with the client device. Step 6810-1 includes storing the user identification data associated with the ticket NFT to facilitate a ticket transaction by the user via the ticket NFT. This storing can be stored as NFT metadata with the ticket NFT itself and/or in conjunction with a wallet associated with the client device.

The user identification data can include one or more passwords, answers to security questions, identifiers of recognized devices such as a device identifier of a personal cellphone, laptop, tablet, computer or other known and/or trusted client device, one or more trusted networks of the user, other multifactor authentication data such as personal information, known answers to security questions, biometric data related to fingerprints, retinal scans, facial features or other biometrics of the user and/or other user identification data that can be used to determine if a user is authenticated.

FIGS. 12C-12D present a block/flow diagram representations of example systems. In the example shown in FIG. 12C, a client device 825 and associated wallet 6825 engages in a ticket transaction based on a ticket NFT 6822 that is stored in a blockchain system 6820. In various examples the blockchain system 6820 is implemented in conjunction with a ticket reader 6829 that communicates with the blockchain system 6820 via a public or private network (not expressly shown). Furthermore, the client device 825 includes a communication interface such as a network interface 220 that enables wireless communication with wallet 6825 (when implemented separately from the client device 825) and that also enables wireless communications with the ticket reader 6829. The wireless communications between the client device 825 and the ticket reader 6829 can be via near-field communications (NFC), Bluetooth signaling, Bluetooth low energy signaling, WiFi signaling or via other communication protocol.

In various examples, the client device 825 operates in response to a ticket transaction request 6832 associated with a ticket NFT 6822. This ticket transaction request 6832 can be received (internally) via a user interface (such as a graphical user interface) associated with the client device 825 and/or received from an external device such as ticket reader 6829 when the client device 825 is placed in proximity to the ticket reader to facilitate the transaction. Transaction metadata 6834 is generated, for example, to begin the process to determine if the ticket transaction request can be validated. The transaction metadata 6834 is sent to the wallet 6825 containing a private key associated with the ticket NFT 6822 associated with a user, such as a user of the client device 825. The client device 825 receives from the wallet 6825, a transaction response 6835 that is generated based on the private key. The client device 825 generates, based on the transaction response 6836, an ownership check 6836 that is sent to the blockchain system 6820 that stores the ticket NFT 6822. An ownership validation response 6838 is received from the blockchain system 6820 that indicates the ticket transaction is approved when the ownership of the ticket NFT is verified and indicates the ticket transaction is denied when ownership of the ticket NFT 6822 is not verified.

In various examples, the transaction metadata 6834 can include identification data indicating a particular ticket NFT 6822 to be accessed via the wallet 6825, a current date and time, and/or user identification data associated with the user of the client device 825 and/or other data used by the wallet 825 to identify the ticket NFT 6822 and authorize access to the wallet by the user of the client device 825. The transaction response 6835 can include a public key associated with the ticket NFT 6822, a signed hash that is based on the private key, the transaction metadata 6834, and/or other data/metadata to be used to validate the NFT data from the wallet 6825 to the ticket NFT 6822.

The ownership check 6836 can include information from the launch response 6835, additional owner/user information, such as user authentication data, associated with the user and/or owner of the ticket NFT 6822 and or other and/or other data/metadata to be used to validate the NFT data from the wallet 6825 to the ticket NFT 6822. In various examples, the blockchain system 6820 can include an NFT transaction authenticator, a secure real-time NFT metadata repository and an NFT source that stores the ticket NFT 6822 on a blockchain or other decentralized computer system/network. In addition or in the alternative, user authentication/NFT validation can also take place, as will be described in conjunction with FIGS. 12G and 12P-12T that follow.

FIG. 12D presents a block diagram representation of an example system. This system operates similarly to the system of FIG. 12C, however, the ticket transaction request 6832 is received directly by the wallet 6825.

In addition or in the alternative, the client device 825 includes a communication interface configured to engage in wireless communications, a processor and a memory configured to store operational instructions, that when executed by the processor, cause the processor to perform operations, These operations can include:
receiving a ticket transaction request for a ticket transaction having a ticket NFT associated therewith;
generating, in response to the ticket transaction request, transaction metadata that includes user identification data;
sending the transaction metadata to a wallet associated with a user of the client device, the wallet containing a private key associated with the ticket NFT;
receiving, from the wallet, a transaction response that is generated based on the private key;
generating, based on the transaction response, ownership check data;
sending the ownership check data to a blockchain system that stores the ticket NFT;
receiving, from the blockchain system, an ownership validation response; and
indicating approval of a ticket transaction when ownership of the ticket NFT is verified.

In various examples, the client device 825 further includes a user interface, such as user interface 262 having a touch screen display. The operations of the client device can further include generating a graphical user interface in conjunction with the touch screen display, wherein the ticket transaction request is received via the graphical user interface, and wherein the approval of the ticket transaction is indicated via the graphical user interface. The operations can further include indicating, via the graphical user interface, denial of the ticket transaction when ownership of the ticket NFT is not verified. The ownership check data can include NFT identification data associated with the ticket NFT, NFT authentication data generated based on the private key and user identification data associated with the user of the client device. The ownership validation response can indicate whether or not ownership of the ticket NFT is verified. The ownership validation response can indicate ownership of the ticket NFT is verified when the ticket NFT is authenticated based on the NFT authentication data and when the user of the client device is identified based on the user identification data. The ownership validation response, in particular, can include credentials data to facilitate the ticket transaction when ownership of the ticket NFT is verified. The user identification data associated with the user of the client device can include a user device identifier associated with the client device and/or user biometric data generated via the client device. The ownership check data can be sent to the blockchain system via wireless communications with a ticket reader and wherein the ownership validation response is received from the blockchain system via the ticket reader.

In various examples, the ticket associated with the ticket NFT and the ticket NFT itself can both be expended when the ticket transaction is approved. Alternatively, the ticket associated with the ticket NFT can be expended when the ticket transaction is approved—however the ticket NFT may not expended when the ticket transaction is approved. In this fashion, the benefit of the ticket NFT as a collectable continues. In further examples, an updated ticket NFT can be generated and/or the ticket NFT can otherwise be updated in response to approval of the ticket transaction to indicate the user's attendance at the event/venue.

In various examples, the ownership check data includes transaction data, the ticket NFT includes transaction restrictions metadata indicating restrictions, and the ownership validation response indicates ownership of the ticket NFT is verified only when the restrictions are met. These restrictions can include day or week or time of day restrictions, restrictions indicating no reentry, restrictions on the number of times a ticket may be used, an expiration date for the ticket, access restrictions on areas to be accessed, and/or other use conditions. Examples of these other use conditions include requiring the user to hold one or more other NFTs in the user's wallet, requiring the user to scan a QR code at the venue, requiring the client device to be within a particular geographical area associated with the venue and/or other conditions. The ownership validation response can indicate ownership of the ticket NFT is verified only when these restriction and/or other use conditions are met.

FIG. 12E presents a flowchart representation 6800-2 of an example method. In particular, a method is presented for use in conjunction with one or more functions or features described herein. Step 6802-2 includes receiving a ticket transaction request for aa ticket transaction having a ticket NFT associated therewith. Step 6804-2 includes generating, in response to the ticket transaction request, transaction metadata that includes user identification data. Step 6806-2 includes sending the transaction metadata to a wallet associated with a user of a client device, the wallet containing a private key associated with the ticket NFT. Step 6808-2 includes receiving, from the wallet, a transaction response that is generated based on the private key. Step 6810-2 includes generating, based on the transaction response, ownership check data.

Step 6812-2 includes sending the ownership check data to a blockchain system that stores the ticket NFT. Step 6814-2 includes receiving, from the blockchain system, an ownership validation response indicating approval of the ticket transaction when ownership of the ticket NFT is verified. Step 6816-2 includes receiving, from the blockchain system, an ownership validation response indicating denial of the ticket transaction when ownership of the ticket NFT is not verified.

In various examples the method further includes generating a graphical user interface in conjunction with a touch screen display, wherein the ticket transaction request is received via the graphical user interface, and wherein the approval of the ticket transaction is indicated via the graphical user interface and/or indicating, via the graphical user interface, denial of the ticket transaction when ownership of the ticket NFT is not verified.

In various examples, the ownership check data includes NFT identification data associated with the ticket NFT, NFT authentication data generated based on the private key and user identification data associated with the user of the client device. The ownership validation response can indicate ownership of the ticket NFT is verified when the ticket NFT is authenticated based on the NFT authentication data and when the user of the client device is identified based on the user identification data. In various examples, the ticket associated with the ticket NFT is expended when the ticket transaction is approved while the ticket NFT is not expended when the ticket transaction is approved.

FIG. 12F presents a flowchart representation 6800-3 of an example method. In particular, a method is presented for use in conjunction with one or more functions or features described herein. Step 6802-3 includes receiving a ticket transaction request for aa ticket transaction having a ticket NFT associated therewith. Step 6804-3 includes generating, in response to the ticket transaction request, transaction metadata that includes user identification data. Step 6806-3 includes sending the transaction metadata to a wallet associated with a user of a client device, the wallet containing a private key associated with the ticket NFT. Step 6808-3 includes receiving, from the wallet, a transaction response that is generated based on the private key. Step 6810-3 includes generating, based on the transaction response, ownership check data.

Step 6812-3 includes sending the ownership check data to a blockchain system that stores the ticket NFT. Step 6814-3 includes receiving, from the blockchain system, an ownership validation response indicating approval of the ticket transaction when ownership of the ticket NFT is verified. Step 6816-3 includes expending a ticket associated with the NFT without expending the ticket NFT—when the ticket transaction is approved.

FIG. 12G presents a block diagram of an example system. In particular, a system is shown that can be implemented similarly to, or in conjunction with, NFT collection platform 800 and/or client device 825. The system includes an NFT transaction authenticator 6022 and a secure real-time NFT metadata repository 6024. In various examples, the NFT transaction authenticator 6022 and the secure real-time NFT metadata repository 6024 can be implemented via one or more modules that include a network interface, processing circuitry and memory. The secure real-time NFT metadata repository 6024 stores NFT metadata received in conjunction with NFTs, created via metadata source 6026, such as one or more NFT creation systems 824. The NFTs, such as ticket NFTs 6822 or other NFTs, are associated with one or more users 6020 of associated client devices 825.

In operation, the NFT transaction authenticator 6022 responds to transaction requests from a user associated with an NFT to authenticate the NFT and the user and to otherwise determine the validity of the transaction that is requested. If the user and the NFT are both authenticated, and the requested transaction is otherwise permissible (e.g., not restricted by conditions on use or other transaction restrictions), then the NFT transaction authenticator 6022 responds by issuing credentials to facilitate the transaction, such as a ticket transaction or other transaction, with a third party 6028. As will be discussed herein, the maintenance and use of the secure real-time NFT metadata repository 6024 allows authentication of NFT related transactions in real-time—avoiding possible delays in performing, for example, complex blockchain transactions via an NFT source 6026 where the NFT was minted and/or otherwise maintained.

Consider the following example where an NFT is created via NFT source 6026. In addition to other NFT data, the NFT has metadata that uniquely identifies the NFT, a hash or other NFT authentication metadata that can be used to authenticate the NFT and/or transaction restriction metadata indicating possible restrictions on transactions/use conditions involving the NFT. Furthermore, when the NFT is created and/or acquired by a user, user-specific user authentication metadata is acquired or created and stored on the blockchain with the NFT with the other metadata. This user authentication metadata can include one or more passwords, answers to security questions, identifiers of recognized devices such as a device identifier of a personal cellphone, laptop, tablet, computer or other known and/or trusted device, one or more trusted networks of the user, other multifactor authentication data such as personal information, known answers to security questions, biometric data related to fingerprints, retinal scans, facial features or other biometrics of the user and/or other user authentication data that can be used to determine if a user is the owner of the NFT or otherwise an authorized user and in particular, whether or not the user is (or is not) who they claim to be.

The metadata associated with the NFT is indexed by NFT identifier and stored on the secure real-time NFT metadata repository 6024 for use by the NFT transaction authenticator 6022 in authenticating NFT-related transactions. This metadata is available from the repository on a real-time basis (e.g., is available with an acceptable amount of latency associated with a corresponding transaction). The metadata in the secure real-time NFT metadata repository 6024 is also synced periodically with the NFT via the NFT source 6026 to reflect any changes/updates in the NFT itself made, for example, by minting updated NFTs on the blockchain or an associated parachain. While some metadata, such as an NFT identifier, NFT authentication metadata and/or transaction restriction metadata may be made accessible to the user who holds the NFT, in various examples, the user authentication metadata in particular, can be encrypted in such a fashion that is decryptable by the secure real-time NFT metadata repository 6024—but not by the user. In various examples, the secure real-time NFT metadata repository 6024 lacks a general network connection and is connected to the NFT transaction authenticator 6022 via a dedicated and/or otherwise secured connection or is otherwise walled-off from other network connections of the NFT transaction authenticator 6022. This helps prevent unauthorized tampering with the sensitive data stored therein.

When a user 6020 proposes an NFT-related transaction, the NFT transaction authenticator 6022 collects from the user as part of the transaction request (a) an identifier of the NFT, and NFT authentication data corresponding to the NFT (b) user authentication data user, and (c) information (transaction data) on the proposed transaction. The NFT transaction authenticator 6022 determines whether or not the identifier corresponds to a valid NFT. If so, it retrieves the metadata associated with the NFT from secure real-time NFT metadata repository 6024. The NFT transaction authenticator 6022 authenticates the NFT by comparing the NFT authentication data to the NFT authentication metadata to determine if they match. The NFT transaction authenticator 6022 can also authenticate the user 6020 to the NFT by comparing the user authentication data to the user authentication metadata to determine if they match. If authentication succeeds, the NFT transaction authenticator 6022 facilitates the transaction with the third party 6028 by authorizing completion of the transaction, e.g. by issuing a credential to the third party 6028. The credential can include any message, object, or data structure that vouches for the identity of the user, the authenticity of the NFT and/or the validity of the transaction, through some method of security, trust and/or authentication.

In this fashion, the NFT transaction authenticator 6022 can authenticate transactions such as access to a flight via a driver's license or passport NFT, sale of a vehicle, real estate via a title NFT, a credit, debit or gift card transaction via a credit, debit or gift card NFT, the sale of a stock or bond via a stock or bond certificate NFT, warranty transactions via a warranty card NFT, access to events via venue ticket NFTs and/or vaccination card NFTs, coupon redemption via a coupon NFT, access to a vehicle, dwelling or office via a key NFT, etc. Furthermore, the NFT transaction authenticator 6022 can authenticate transactions such as sales and/or micro-loans of NFTs itself.

It should be noted that some NFTs are conditional, e.g. that have restrictions on their use and/or the transactions that are permitted. Depending on the type of transaction, the NFT transaction authenticator 6022 can also operate to compare transaction data received from the user to transaction restrictions metadata to determine if a transaction is permitted—before it is authorized. In this fashion, a ticket transaction can be halted if an expiration date or transaction limit has been exceeded.

Furthermore, when sales transactions involving an NFT such as a ticket NFT, have been authorized, the NFT transaction authenticator 6022 can also operate to note the sale (and/or pending sale) in the secure real-time NFT metadata repository 6024 or otherwise place a hold on the NFT to prevent another sales until the repository is updated in a future sync with the NFT source 6026. The NFT transaction authenticator 6022 can also operate to determine that the NFT is expended, based on the transaction restrictions metadata and the transaction data. In response to such a determination, NFT transaction authenticator 6022 can then update the secure real-time NFT metadata repository to indicate the NFT is expended. In any of these cases above, the secure real-time NFT metadata repository may facilitate updating of the NFT source 6026 to reflect an authorized transaction via notifications and/or that an NFT has been expended.

In various examples, the secure real-time NFT repository is implemented via a layer two or higher blockchain, a parachain, an InterPlanetary File System (IPFS) or other decentralized or distributed computer system of individual computers and/or nodes and/or a centralized computing system that is updated based on the one or more blockchain systems of NFT source 6026.

In the example shown, the NFT transaction authenticator 6022 includes: a communication interface 6031 configured to engage in wireless communications; a processor 6037; and a memory 6033 configured to store operational instructions, that when executed by the processor 6037, cause the processor 6037 to perform operations that include:
receiving NFT metadata associated with a plurality of ticket NFTs minted via one or more blockchain systems, the NFT metadata for each of plurality of ticket NFTs including NFT identification metadata for identifying a corresponding ticket NFT of the plurality of ticket NFTs, NFT authentication metadata for authenticating the corresponding ticket NFT of the plurality of ticket NFTs, user authentication metadata for authenticating an authorized user of the corresponding ticket NFT of the plurality of ticket NFTs;
storing the NFT metadata in a secure real-time NFT repository, wherein the secure real-time NFT repository is separate from the one or more blockchain systems; and
facilitating, via the secure real-time NFT repository, real time authentication for ticket transactions associated with ones of the plurality of ticket NFTs.

In various examples, facilitating real time authentication for ticket transactions includes generating credentials data to facilitate one of the ticket transactions when the corresponding ticket NFT is authenticated and the authorized user of the corresponding ticket NFT is authenticated. Facilitating real time authentication for ticket transactions can further include:
receiving a transaction request from a user associated with one of the plurality of ticket NFTs and a corresponding ticket transaction, wherein the transaction request includes NFT identification data identifying the one of the plurality of ticket NFTs, NFT authentication data and user identification data associated with the user;
receiving NFT metadata associated with the one of the plurality of ticket NFTs from the secure real-time NFT repository; and
determining that the one of the plurality of ticket NFTs is authenticated when the NFT authentication data compares favorably to (i.e., matches) the NFT authentication metadata of the NFT metadata associated with the one of the plurality of ticket NFTs;
determining that the one of the plurality of ticket NFTs is authenticated when the NFT authentication data compares favorably to (i.e., matches) the NFT authentication metadata of the NFT metadata associated with the one of the plurality of ticket NFTs; and
determining that the authorized user is authenticated when the user authentication data compares favorably to (i.e., matches) the user authentication metadata of the NFT metadata associated with the one of the plurality of ticket NFTs.

Facilitating real time authentication for ticket transactions can further include generating credentials data to facilitate the corresponding ticket transaction when the one of the plurality of ticket NFTs is authenticated and the authorized user is authenticated. The NFT metadata can further include transaction restrictions metadata indicating transaction restrictions, the transaction request can include transaction data and facilitating real time authentication for ticket transactions further includes: determining that the corresponding ticket transaction is authorized when the transaction data compares favorably to (i.e., matches) the transaction restrictions metadata of the NFT metadata associated with the one of the plurality of ticket NFTs; and generating credentials data to facilitate the corresponding ticket transaction when the one of the plurality of ticket NFTs is authenticated, the authorized user is authenticated, and the corresponding ticket transaction is authorized.

The NFT metadata can further include conditions metadata indicating NFT conditions, the transaction request can include conditions data and facilitating real time authentication for ticket transactions can further include: determining that the NFT conditions are satisfied when the conditions data compares favorably to (i.e., matches) the conditions metadata of the NFT metadata associated with the one of the plurality of ticket NFTs; and generating credentials data to facilitate the corresponding ticket transaction when the one of the plurality of ticket NFTs is authenticated, the authorized user is authenticated, and the NFT conditions are satisfied.

In various examples, the user authentication data includes a device identifier associated with a device of the authorized user and/or biometric data associated with the authorized user generated by a device of the authorized user. The ticket transactions can include a sale of at least one of the plurality of ticket NFTs and wherein the operations can further include: updating the NFT metadata corresponding to the at least one of the plurality of ticket NFTs to indicate the sale; and storing the updated NFT metadata in the secure real-time NFT repository.

FIG. 12H presents a flowchart representation of an example method. In particular, a method 6000-1 is presented for use in conjunction with any of the functions and features previously described. Step 6002-1 includes receiving NFT metadata associated with a plurality of ticket NFTs minted via one or more blockchain systems, the NFT metadata for each of plurality of ticket NFTs including NFT identification metadata for identifying a corresponding ticket NFT of the plurality of ticket NFTs, NFT authentication metadata for authenticating the corresponding ticket NFT of the plurality of ticket NFTs, user authentication metadata for authenticating an authorized user of the corresponding ticket NFT of the plurality of ticket NFTs. Step 6004-1 includes storing the NFT metadata in a secure real-time NFT repository, wherein the secure real-time NFT repository is separate from the one or more blockchain systems. Step 6006-1 includes facilitating, via the secure real-time NFT repository, real time authentication for ticket transactions associated with ones of the plurality of ticket NFTs.

FIG. 12I presents a flowchart representation of an example method. In particular, a method 6000-2 is presented for use in conjunction with any of the functions and features previously described. Step 6002-2 includes receiving, at the processor, NFT metadata associated with a plurality of ticket NFTs minted via one or more blockchain systems, the NFT metadata including NFT identification metadata for identifying a ticket NFT of the plurality of ticket NFTs, NFT authentication metadata for authenticating the ticket NFT of the plurality of ticket NFTs, user authentication metadata for authenticating an authorized user of the ticket NFT of the plurality of plurality of ticket NFTs, and transaction restriction metadata associated with transaction restrictions. Step 6004-2 includes storing the NFT metadata in a secure real-time NFT repository, wherein the secure real-time NFT repository is separate from the one or more blockchain systems. Step 6006-2 includes facilitating, via the secure real-time NFT repository, real time authentication for ticket transactions associated with ones of the plurality of ticket NFTs.

FIG. 12J presents a flowchart representation of an example method. In particular, a method 6000-3 is presented for use in conjunction with any of the functions and features previously described. Step 6002-3 includes receiving, at the processor, a transaction request from a user associated with a ticket NFT minted via a blockchain, wherein the transaction request includes NFT identification data identifying the ticket NFT, NFT authentication data and user identification data. Step 6004-3 includes receiving, from a secure real-time NFT metadata repository and in response to the NFT identification data, NFT authentication metadata for authenticating the ticket NFT and user authentication metadata for authenticating an authorized user of the ticket NFT, wherein the secure real-time NFT metadata repository is separate from the blockchain.

Step 6006-3 includes determining, via the processor, that the ticket NFT is authenticated when the NFT authentication data compares favorably to the NFT authentication metadata. Step 6008-4 includes determining, via the processor, that the user is authenticated when the user authentication metadata compares favorably to the user identification data. Step 6010-3 includes generating credentials data to facilitate a ticket transaction when the ticket NFT is authenticated and the user is authenticated.

FIG. 12K presents a flowchart representation of an example method. In particular, a method 6000-4 is presented for use in conjunction with any of the functions and features described herein. Step 6002-4 includes receiving, at the processor, a transaction request from a user associated with a ticket NFT minted via a blockchain, wherein the transaction request includes NFT identification data identifying the ticket NFT, NFT authentication data, user identification data and transaction data associated with a ticket transaction. Step 6004-4 includes receiving, from a secure real-time NFT metadata repository and in response to the NFT identification data, NFT authentication metadata for authenticating the ticket NFT, user authentication metadata for authenticating an authorized user of the ticket NFT, and transaction restrictions data associated with the ticket NFT, wherein the secure real-time NFT metadata repository is separate from the blockchain.

Step 6006-4 includes determining, via the processor, that the ticket NFT is authenticated when the NFT authentication data compares favorably to the NFT authentication metadata. Step 6008-4 includes determining, via the processor, that the user is authenticated when the user authentication metadata compares favorably to the user identification data. Step 6010-4 includes determining, via the processor, that the ticket transaction is authorized when the transaction restrictions metadata compares favorably to the transaction data. Step 6012-4 includes generating credentials data to facilitate the transaction when the ticket NFT is authenticated, the user is authenticated and the ticket transaction is authorized.

FIG. 12J presents a flowchart representation of an example method. In particular, a method 6000-5 is presented for use in conjunction with any of the functions and features previously described. Step 6002-5 includes receiving, at the processor, a transaction request from a user associated with a ticket NFT minted via a blockchain, wherein the transaction request includes NFT identification data identifying the ticket NFT, NFT authentication data, user identification data and conditions data associated with a ticket transaction, wherein the ticket NFT is a conditional NFT having conditions on use. Step 6004-5 includes receiving, from a secure real-time NFT metadata repository and in response to the NFT identification data, NFT authentication metadata for authenticating the ticket NFT, user authentication metadata for authenticating an authorized user of the ticket NFT, and conditions metadata associated with the ticket NFT indicating the conditions on use, wherein the secure real-time NFT metadata repository is separate from the blockchain.

Step 6006-5 includes determining, via the processor, that the ticket NFT is authenticated when the NFT authentication data compares favorably to the NFT authentication metadata. Step 6008-5 includes determining, via the processor, that the user is authenticated when the user authentication metadata compares favorably to the user identification data. Step 6010-5 includes determining, via the processor, that the NFT conditions are satisfied when the conditions metadata compares favorably to the conditions data. Step 6012-5 includes generating credentials data to facilitate the transaction when the ticket NFT is authenticated, the user is authenticated and the NFT conditions are satisfied.

FIG. 12M presents a flowchart representation of an example method. In particular, a method 6000-6 is presented for use in conjunction with any of the functions and features previously described. Step 6002-6 includes receiving, at the processor, a transaction request from a user associated with a ticket NFT minted via a blockchain, wherein the transaction request includes NFT identification data identifying the ticket NFT, NFT authentication data, user identification data and transaction data indicating that a ticket transaction corresponds to a sale of the ticket NFT. Step 6004-6 includes receiving, from a secure real-time NFT metadata repository and in response to the NFT identification data, NFT authentication metadata for authenticating the ticket NFT and user authentication metadata for authenticating an authorized user of the ticket NFT, wherein the secure real-time NFT metadata repository is separate from the blockchain.

Step 6006-6 includes determining, via the processor, that the ticket NFT is authenticated when the NFT authentication data compares favorably to the NFT authentication metadata. Step 6008-6 includes determining, via the processor, that the user is authenticated when the user authentication metadata compares favorably to the user identification data. Step 6010-6 includes generating credentials data to facilitate the transaction when the ticket NFT is authenticated, the user is authenticated and the ticket transaction is authorized. Step 6012-6 includes updating the secure real-time NFT metadata repository to indicate a pending sale of the ticket NFT.

FIG. 12N presents a flowchart representation of an example method. In particular, a method 6000-7 is presented for use in conjunction with any of the functions and features previously described. Step 6002-7 includes receiving, at the processor, a transaction request from a user associated with a ticket NFT minted via a blockchain, wherein the transaction request includes NFT identification data identifying the ticket NFT, NFT authentication data, user identification data and transaction data associated with a ticket transaction. Step 6004-7 includes receiving, from a secure real-time NFT metadata repository and in response to the NFT identification data, NFT authentication metadata for authenticating the ticket NFT and user authentication metadata for authenticating an authorized user of the ticket NFT, wherein the secure real-time NFT metadata repository is separate from the blockchain.

Step 6006-7 includes determining, via the processor, that the ticket NFT is authenticated when the NFT authentication data compares favorably to the NFT authentication metadata. Step 6008-7 includes determining, via the processor, that the user is authenticated when the user authentication metadata compares favorably to the user identification data. Step 6010-7 includes generating credentials data to facilitate the ticket transaction when the ticket NFT is authenticated, the user is authenticated and the ticket transaction is authorized. Step 6012-7 includes determining, via the processor, that the ticket NFT is expended, based on the transaction restrictions metadata and the transaction data and, in response, updating the secure real-time NFT metadata repository to indicate the ticket NFT is expended.

FIG. 12O presents a pictorial block diagram/flow representation of an example of transaction authentication. A client device, such as client device 825, presents a screen display 6050 indicating that a particular NFT has been selected in conjunction with a proposed transaction with a third party 6028. In the example shown, the user has chosen to redeem a venue ticket for admission into an event venue for a corresponding event. The user then identifies himself/herself to the client device via biometrics such as fingerprints, facial recognition, retinal scan and/or other biometrics and/or other authentication data. When the user is positively identified, as indicated in display screen 6052, the client device forwards the transaction request 6054-1 to the NFT transaction authenticator 6022. In this case, the transaction request 6054-1 includes NFT identification data identifying the ticket NFT, NFT authentication data, and also user identification data that includes a user device identifier.

The NFT transaction authenticator 6022 can operate in conjunction with the secure real-time NFT metadata repository 6024 for example, to authenticate the transaction with the third party 6028. In this case, the user authentication mechanisms of the client device 825 are used in the transaction as part of the authentication process. Once the user is identified by a trusted device, only the identification of the trusted device is required as user authentication data forwarded as part of the request.

FIG. 12P presents a pictorial block diagram/flow representation of a further example of transaction authentication. In this case, the transaction request 6054-2 includes NFT identification data identifying the NFT, NFT authentication data, and also user identification data that includes user biometric data that was collected via the client device 825 as part of its own user authentication process.

Again, the NFT transaction authenticator 6022 can operate in conjunction with the secure real-time NFT metadata repository 6024 for example, to authenticate the transaction with the third party 6028. In this case, the user authentication mechanisms of the client device are again used in the transaction of the authentication process. Once the user biometric data is collected, it is forwarded as part of the request for use in authenticating the user—without the need for identification of the device itself.

FIG. 12Q presents a pictorial block diagram/flow representation of a further example of transaction authentication. In this case, the transaction request 6054-3 includes NFT identification data identifying the NFT, NFT authentication data, and also user identification data that includes both a user device identifier and user biometric data that was collected via the client device 825 as part of its own user authentication process.

Again, the NFT transaction authenticator 6022 can in operate in conjunction with the secure real-time NFT metadata repository 6024 for example, to authenticate the transaction with the third party 6028. In this additional case, the user authentication mechanisms of the client device are used in the transaction of the authentication process. Once the user is identified by a trusted device, the device identifier of the trusted device can be in combination with the user biometrics collected by that device to provide further security for the proposed transaction.

FIG. 12R presents a flowchart representation of an example method. In particular, a method 6000-8 is presented for use in conjunction with any of the functions and features described herein. Step 6002-8 includes receiving, at the processor, a transaction request from a user associated with a ticket NFT minted via a blockchain, wherein the transaction request includes NFT identification data identifying the ticket NFT, NFT authentication data and user identification data that includes a user device identifier. Step 6004-8 includes receiving, from a secure real-time NFT metadata repository and in response to the NFT identification data, NFT authentication metadata for authenticating the ticket NFT and user authentication metadata for authenticating an authorized user of the ticket NFT, wherein the secure real-time NFT metadata repository is separate from the blockchain.

Step 6006-8 includes determining, via the processor, that the ticket NFT is authenticated when the NFT authentication data compares favorably to the NFT authentication metadata. Step 6008-8 includes determining, via the processor, that the user is authenticated when the user authentication metadata compares favorably to the user identification data. Step 6010-8 includes generating credentials data to facilitate a ticket transaction when the ticket NFT is authenticated and the user is authenticated.

FIG. 12S presents a flowchart representation of an example method. In particular, a method 6000-9 is presented for use in conjunction with any of the functions and features previously described. Step 6002-9 includes receiving, at the processor, a transaction request from a user associated with a ticket NFT minted via a blockchain, wherein the transaction request includes NFT identification data identifying the ticket NFT, NFT authentication data and user identification data that includes user biometric data. Step 6004-9 includes receiving, from a secure real-time NFT metadata repository and in response to the NFT identification data, NFT authentication metadata for authenticating the ticket NFT and user authentication metadata for authenticating an authorized user of the ticket NFT, wherein the secure real-time NFT metadata repository is separate from the blockchain.

Step 6006-9 includes determining, via the processor, that the ticket NFT is authenticated when the NFT authentication data compares favorably to the NFT authentication metadata. Step 6008-9 includes determining, via the processor, that the user is authenticated when the user authentication metadata compares favorably to the user identification data. Step 6010-9 includes generating credentials data to facilitate a ticket transaction when the ticket NFT is authenticated and the user is authenticated.

FIG. 12T presents a flowchart representation of an example method. In particular, a method 6000-10 is presented for use in conjunction with any of the functions and features previously described. Step 6002-10 includes receiving, at the processor, a transaction request from a user associated with a ticket NFT minted via a blockchain, wherein the transaction request includes NFT identification data identifying the ticket NFT, NFT authentication data and user identification data that includes user biometric data and a user device identifier. Step 6004-10 includes receiving, from a secure real-time NFT metadata repository and in response to the NFT identification data, NFT authentication metadata for authenticating the ticket NFT and user authentication metadata for authenticating an authorized user of the ticket NFT, wherein the secure real-time NFT metadata repository is separate from the blockchain.

Step 6006-10 includes determining, via the processor, that the ticket NFT is authenticated when the NFT authentication data compares favorably to the NFT authentication metadata. Step 6008-10 includes determining, via the processor, that the user is authenticated when the user authentication metadata compares favorably to the user identification data. Step 6010-10 includes generating credentials data to facilitate a ticket transaction when the ticket NFT is authenticated and the user is authenticated.

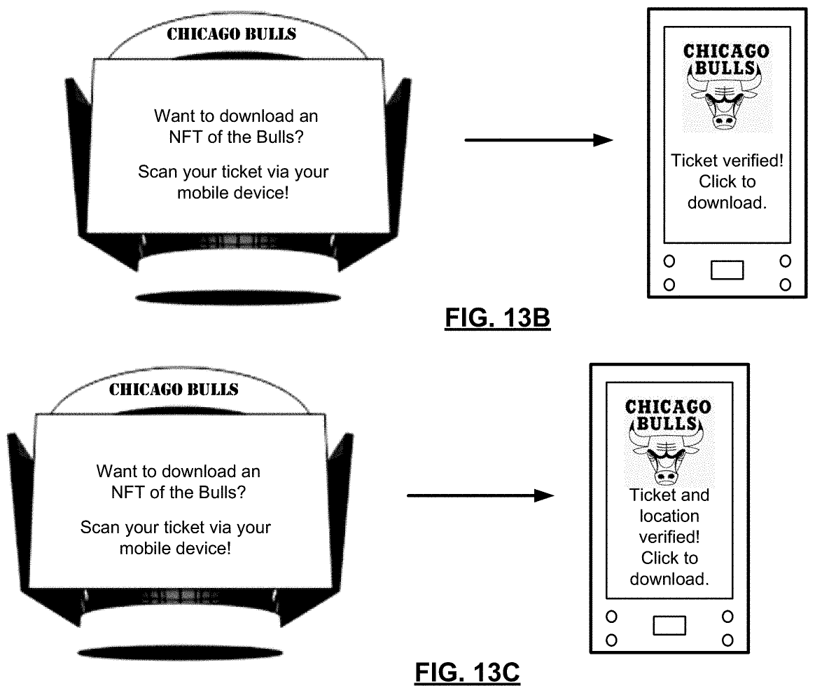

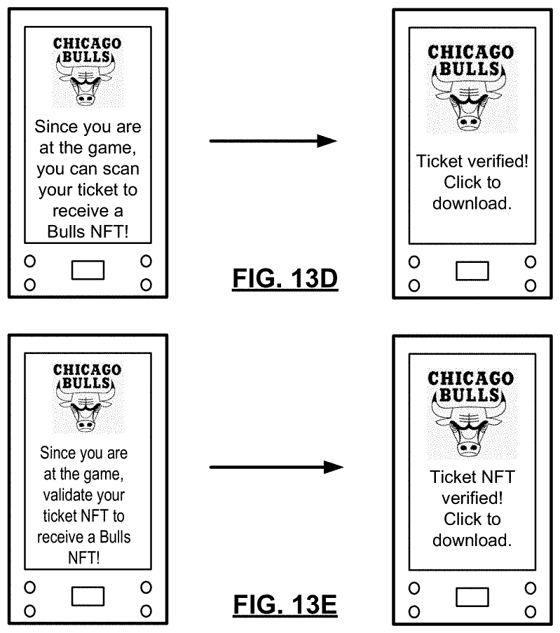

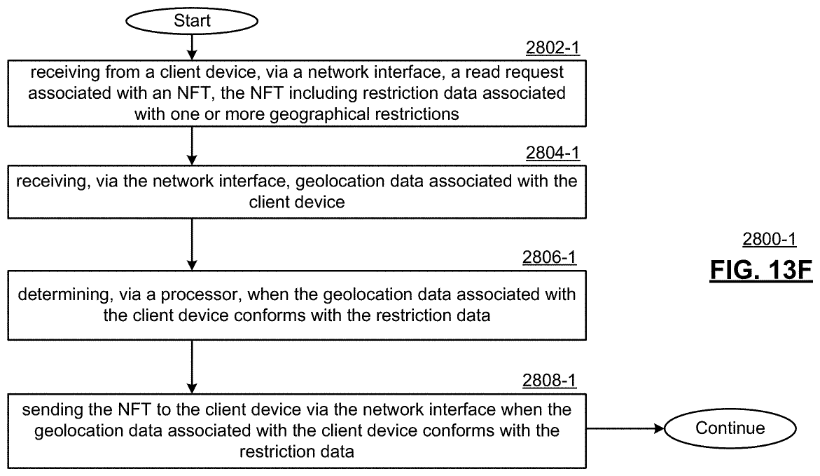

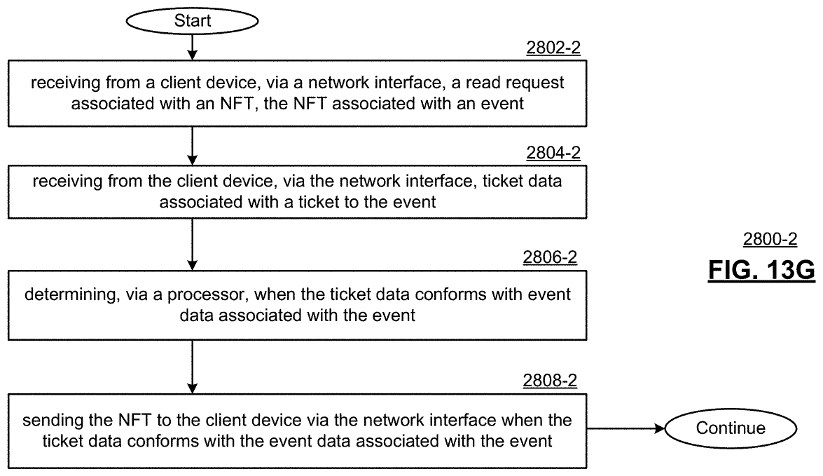

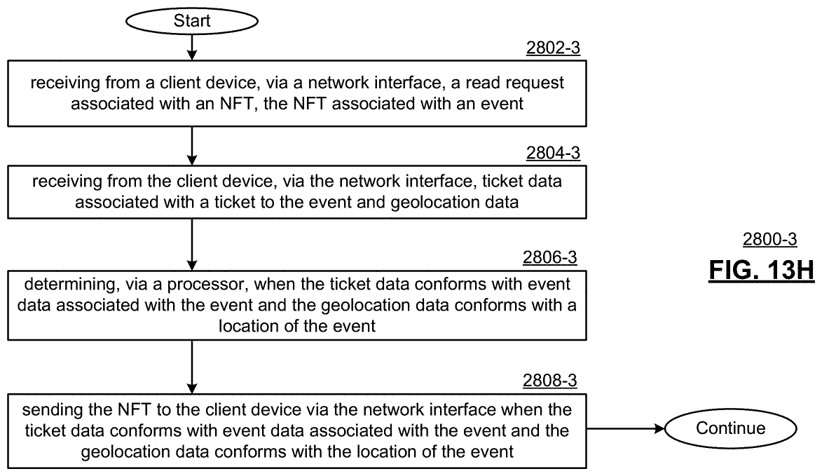

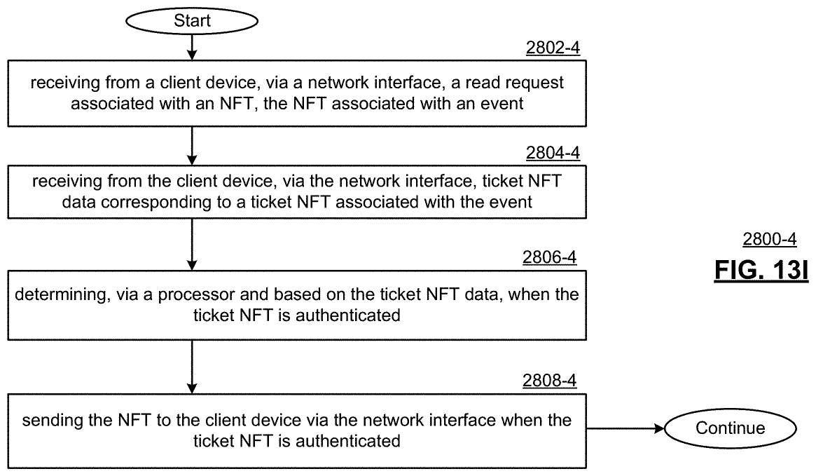

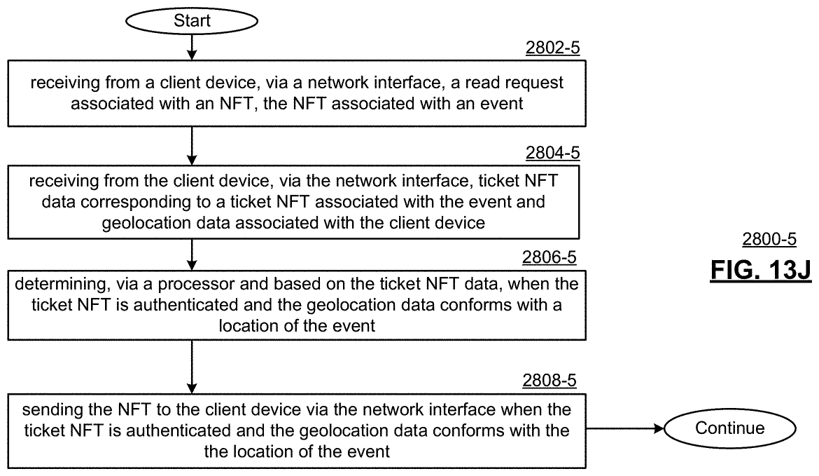

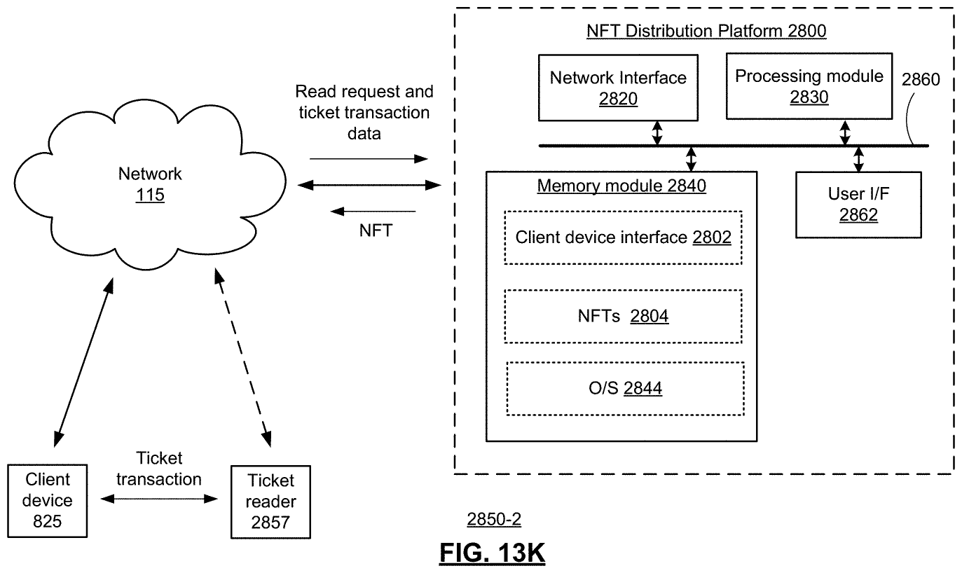

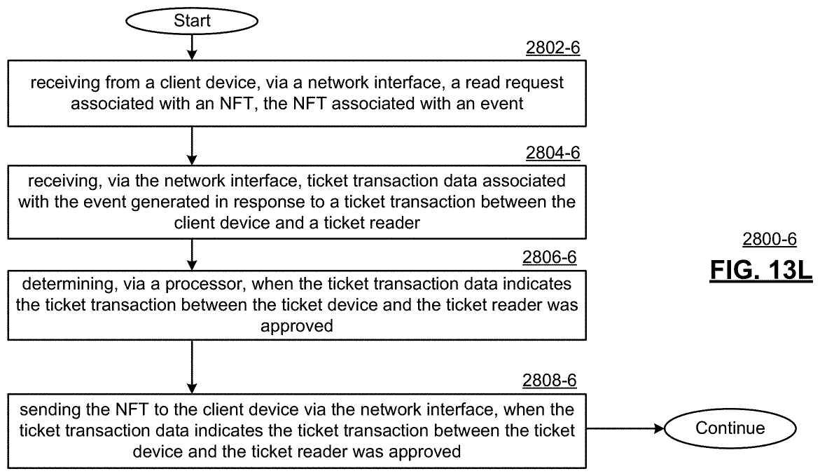

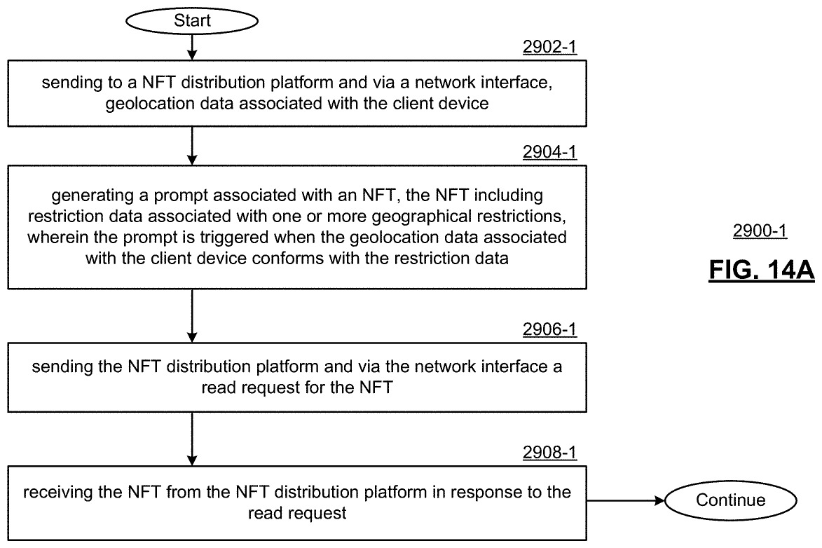

FIG. 13A presents a block diagram representation of an example system. In particular, a system 2850-1 is presented that includes an NFT distribution platform 2800 that communicates with client devices 825 via a network 115 and includes similar elements to FIG. 7 that are referred to by common reference numerals.

In various examples, the NFT distribution platform 2800 can operate to respond to input data from client devices in the form of read requests for NFTs, ticket data corresponding to event tickets, ticket transactions and/or ticket NFT data and/or, geolocation data such as GPS coordinates in connection with or proximity with a network element of network 115 or other location data indicating a location of the client device 825. In various embodiments, the NFT distribution platform 2800 sends the requested NFT(s) to the requesting client device—only when the geolocation data indicates a position of the requesting client device within a limited area or proximity associated with the event. In addition or in the alternative, the NFT distribution platform 2800 sends the requested NFT(s) to the requesting client device—only when the ticket data conforms with event data associated with the event—and for example, is authenticated. In either fashion, the NFTs are distributed only to users that are at the event and/or hold a valid/authentic event ticket for the event.

In various examples, the memory module 2840 is configured to store operational instructions, that when executed by a processor of processing module 2830, cause the processor to perform operations that include:
receiving from a client device, via the network interface, a read request associated with an NFT, the NFT associated with an event;
receiving from the client device, via the network interface, ticket data associated with a ticket to the event;
determining, via the processor, when the ticket data conforms with event data associated with the event; and
sending the NFT to the client device via the network interface when the ticket data conforms with the event data associated with the event.

In various examples, the ticket data includes ticket image data of the ticket generated via the client device and determining when the ticket data conforms with the event data associated with the event, includes authenticating the ticket, based on the ticket image data. Image recognition can be used to read a bar code, QR code or other code or text associated with the ticket in order to extract data from the image that can be compared to the event data to determine whether or not the ticket conforms with the event data—e.g., the ticket is authentic, the ticket is associated with the particular event in progress, the ticket is owned by the user and/or that the ticket has been used to gain access to the event.

In addition or in the alternative, the ticket data includes ticket transaction data corresponding to a ticket transaction between the client device and a ticket reader and determining when the ticket data conforms with the event data associated with the event, includes validating the ticket transaction data. In addition or in the alternative, the ticket data includes ticket NFT data corresponding to a ticket NFT associated with the ticket and wherein determining when the ticket data conforms with the event data associated with the event, includes authenticating the ticket NFT. In any of these scenarios, possession, ownership and/or authentication of a user's ticket, ticket transaction and/or associated ticket NFT along with a verification that such a ticket, ticket transaction and/or ticket NFT corresponds to the event—enables user download of an NFT. This improves the technology of NFT distribution by limiting downloads to user's with valid tickets.

In addition or in the alternative, the operations further include: receiving geolocation data from the client device; determining, via the processor, when the geolocation data conforms with a location of the event; and conditions whereby the NFT is sent to the client device via the network interface—only when the geolocation data conforms with the location of the event. The geolocation data can indicate a location of the client device and determining when the geolocation data conforms with the location of the event can includes determining the location of the client device is within a predetermined proximity of the location. This improves the technology of NFT distribution by limiting downloads to user's that are actually in a predetermined proximity to the event itself.

Furthermore, the client device can include: a network interface configured to communicate via a network; a processor; a memory configured to store operational instructions, that when executed by the processor, cause the processor to perform operations that include:
sending, via the network interface, a read request associated with an NFT, the NFT associated with an event;
sending, via the network interface, ticket data associated with a ticket to the event; and
receiving the NFT in response to determining that the ticket data conforms with the event data associated with the event.
   The operations can further include generating geolocation data—wherein the NFT is received only in response to further determining the geolocation data conforms with the location of the event.

FIG. 13B presents a pictorial representation of an example jumbotron display. In particular, the jumbotron of a sports stadium is shown that displays a prompt to attendees of the event to download NFTs by scanning their ticket with their mobile devices (client devices 825). When the ticket code is scanned, the NFT distribution platform 2800 is automatically accessed by the client device 825 which receives the ticket data along with a request for an NFT. In this example, NFTs are restricted to attendees that have valid tickets to the event. This prevents an attendee/user from downloading the NFT without a valid ticket for an event currently in progress. Once the ticket data is checked, a screen display is shown of client device 825 where the NFT distribution platform 2800 has verified the ticket and has allowed the download of an NFT.

In FIG. 13C, a similar example is shown that also requires physical presence at the event. When the ticket code is scanned, the NFT distribution platform 2800 is automatically accessed by the client device 825 which receives the ticket data, the geolocation data along with a request for an NFT. In this example, NFTs are restricted to attendees that have valid tickets to the event and are physically present at the event. This prevents an attendee from downloading the NFT without a valid ticket for the current event and that are not actually present at the event itself. Once the ticket data and the geolocation data is checked, a screen display is shown of client device 825 where the NFT distribution platform 2800 has verified that the ticket is verified and the location of the client device is within the stadium and has allowed the download of an NFT.

FIG. 13D presents a pictorial representation of example client device displays. In the prior example, the process began with the user of a client device scanning a his or her ticket. In this further example, the NFT distribution platform 2800 has automatically detected the presence of the user at the venue based on geolocation data received from the user's client device 825 and automatically prompted the user to click to scan their ticket. In this fashion, the user is geo-authorized, before the request.

FIG. 13E presents a pictorial representation of example client device displays. In this further example, the NFT distribution platform 2800 has automatically detected the presence of the user at the venue based on geolocation data received from the user's client device 825 and automatically prompted the user to validate a ticket NFT associated with their game ticket. In this fashion, the user is geo-authorized, before the request and download can be enable when their ticket NFT is validated—i.e., is authenticated and determined to correspond to the current event. Authentication of the ticket NFT can be performed in conjunction with the client device 825 by any of the procedures previously described.

FIG. 13F presents a flowchart representation of an example method. In particular, a method 2800-1 is presented for use in conjunction with any of the functions and features previously described. Step 2802-1 includes receiving from a client device, via a network interface, a read request associated with an NFT, the NFT including restriction data associated with one or more geographical restrictions. Step 2804-1 includes receiving, via the network interface, geolocation data associated with the client device. Step 2806-1 includes determining, via a processor, when the geolocation data associated with the client device conforms with the restriction data. Step 2808-1 includes sending the NFT to the client device via the network interface when the geolocation data associated with the client device conforms with the restriction data. As noted above, steps 2802-1 and 2804-1 can be performed in a different order.

FIG. 13G presents a flowchart representation of an example method. In particular, a method 2800-2 is presented for use in conjunction with any of the functions and features previously described. Step 2802-2 includes receiving from a client device, via a network interface, a read request associated with an NFT, the NFT associated with an event. Step 2804-2 includes receiving from the client device, via the network interface, ticket data associated with a ticket to the event. Step 2806-2 includes determining, via a processor, when the ticket data conforms with event data associated with the event. Step 2808-2 includes sending the NFT to the client device via the network interface when the ticket data conforms with the event data associated with the event.

As discussed above, the ticket data can include ticket image data of the ticket generated via the client device and determining when the ticket data conforms with the event data associated with the event, includes authenticating the ticket, based on the ticket image data. Image recognition can be used to read a bar code, QR code or other code or text associated with the ticket in order to extract data from the image that can be compared to the event data to determine whether or not the ticket is authentic, the ticket is associated with the particular event in progress, and/or that the ticket has been used to gain access to the event.

In addition or in the alternative, the ticket data includes ticket transaction data corresponding to a ticket transaction between the client device and a ticket reader and determining when the ticket data conforms with the event data associated with the event, includes validating the ticket transaction data. In addition or in the alternative, the ticket data includes ticket NFT data corresponding to a ticket NFT associated with the ticket and wherein determining when the ticket data conforms with the event data associated with the event, includes authenticating the ticket NFT. In any of these scenarios, possession, ownership and/or authentication of a user's ticket, ticket transaction and/or associated ticket NFT along with a verification that such a ticket, ticket transaction and/or ticket NFT corresponds to the event—enables user download of an NFT. This improves the technology of NFT distribution by limiting downloads to user's with valid tickets.

In addition or in the alternative, the operations further include: receiving geolocation data from the client device; determining, via the processor, when the geolocation data conforms with a location of the event; and conditions whereby the NFT is sent to the client device via the network interface—only when the geolocation data conforms with the location of the event. The geolocation data can indicate a location of the client device and determining when the geolocation data conforms with the location of the event can includes determining the location of the client device is within a predetermined proximity of the location. This improves the technology of NFT distribution by limiting downloads to user's that are actually in a predetermined proximity to the location of the event itself.

FIG. 13H presents a flowchart representation of an example method. In particular, a method 2800-3 is presented for use in conjunction with any of the functions and features previously described. Step 2802-3 includes receiving from a client device, via a network interface, a read request associated with an NFT, the NFT associated with an event. Step 2804-3 includes receiving from the client device, via the network interface, ticket data associated with a ticket to the event and geolocation data. Step 2806-3 includes determining, via a processor, when the ticket data conforms with event data associated with the event and the geolocation data conforms with a location of the event. Step 2808-3 includes sending the NFT to the client device via the network interface when the ticket data conforms with event data associated with the event and the geolocation data conforms with the location of the event.

FIG. 13I presents a flowchart representation of an example method. In particular, a method 2800-4 is presented for use in conjunction with any of the functions and features previously described. Step 2802-4 includes receiving from a client device, via a network interface, a read request associated with an NFT, the NFT associated with an event. Step 2804-4 includes receiving from the client device, via the network interface, ticket NFT data corresponding to a ticket NFT associated with the event. Step 2806-4 includes determining, via a processor and based on the ticket NFT data, when the ticket NFT is authenticated. Step 2808-4 includes sending the NFT to the client device via the network interface when the ticket NFT is authenticated.

FIG. 13J presents a flowchart representation of an example method. In particular, a method 2800-5 is presented for use in conjunction with any of the functions and features previously described. Step 2802-2 includes receiving from a client device, via a network interface, a read request associated with an NFT, the NFT associated with an event. Step 2804-5 includes receiving from the client device, via the network interface, ticket NFT data corresponding to a ticket NFT associated with the event and geolocation data associated with the client device. Step 2806-5 includes determining, via a processor and based on the ticket NFT data, when the ticket NFT is authenticated and the geolocation data conforms with a location of the event. Step 2808-5 includes sending the NFT to the client device via the network interface when the ticket NFT is authenticated and the geolocation data conforms with the location of the event.

FIG. 13K presents a schematic/block diagram representation of an example system. In particular, a system is shown that includes similar elements to the system of FIG. 13A that are referred to by common reference numerals. In addition, the system includes a ticket reader 2857 for engaging in a ticket transaction with client device 825. In various examples, the ticket reader 2857 is located at an event venue and the ticket transaction involves using a ticket associated with a wallet of the client device 825 to gain access to the event. The ticket reader 2857 can be a standard ticket reader, a ticket reader 6829 and/or other ticket reader for operating based on a standard electronic ticket and/or a ticket NFT as previously described. The ticket reader 2857 can communicate via network 115 or via a private network, VPN or other network not expressly shown.

The ticket transaction data generated in response to the ticket transaction can indicate whether or not the ticket transaction was approved and/or other data such as a date and time of the transaction, other ticket data regarding the ticket itself including for example, the type of ticket and/or the type of access provided by the ticket, ticket NFT data and/or user information data. In various embodiments, the ticket transaction data can be sent by the client device 825 to the NFT distribution platform 2800 via the network 115. In addition, or in the alternative, the ticket transaction data can be sent by the ticket reader 2857 to the NFT distribution platform 2800 via the network 115. As previously discussed, ticket transaction data corresponding to a ticket transaction between the client device and a ticket reader can be processed by the NFT distribution platform 2800 to determine when the ticket transaction data and/or the ticket transaction data conforms with the event data. These determination(s) can be used as precondition(s) for sending the NFT to the client device 825 along with optionally other conditions such as client device association with the ticket transaction, geolocation of the client device in proximity to the event, etc.

FIG. 13L presents a flowchart representation of an example method. In particular, a method 2800-6 is presented for use in conjunction with any of the functions and features previously described. Step 2802-6 includes receiving from a client device, via a network interface, a read request associated with an NFT, the NFT associated with an event. Step 2804-6 includes receiving, via the network interface, ticket transaction data associated with the event generated in response to a ticket transaction between the client device and a ticket reader. Step 2806-6 includes determining, via a processor, when the ticket transaction data indicates the ticket transaction between the ticket device and the ticket reader was approved. Step 2808-6 includes sending the NFT to the client device via the network interface, when the ticket transaction data indicates the ticket transaction between the ticket device and the ticket reader was approved.

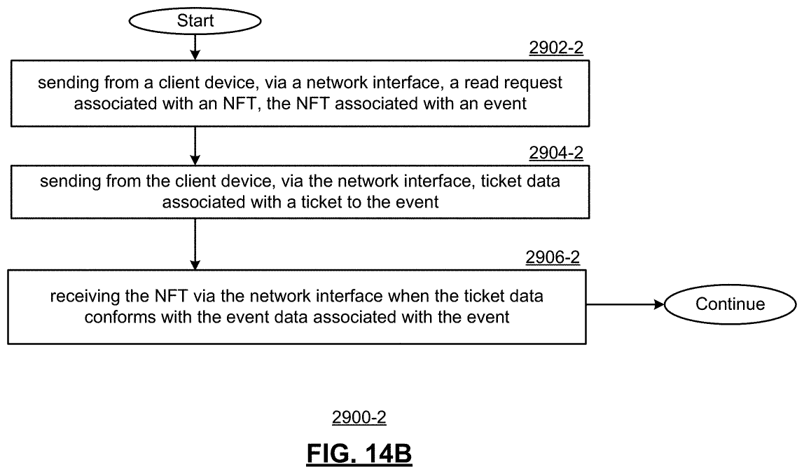

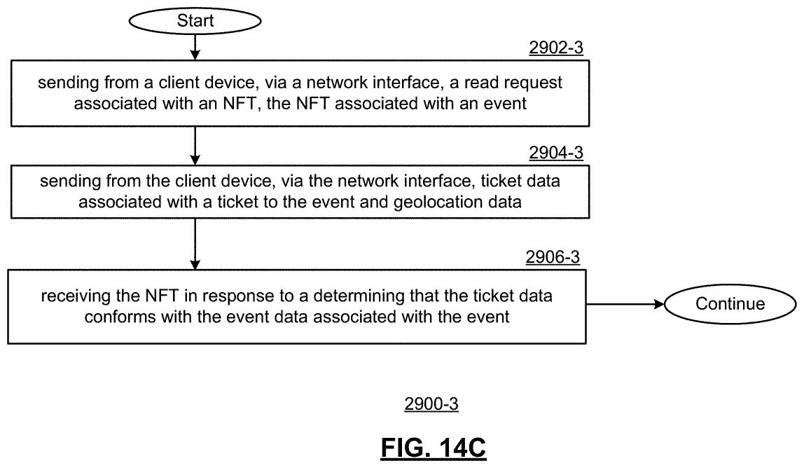

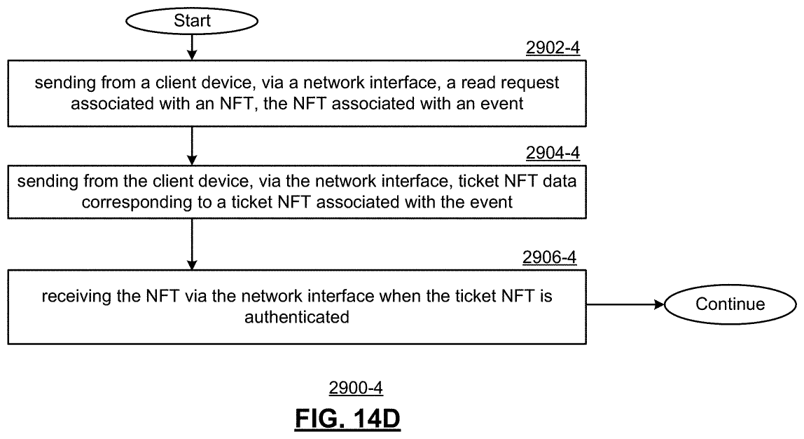

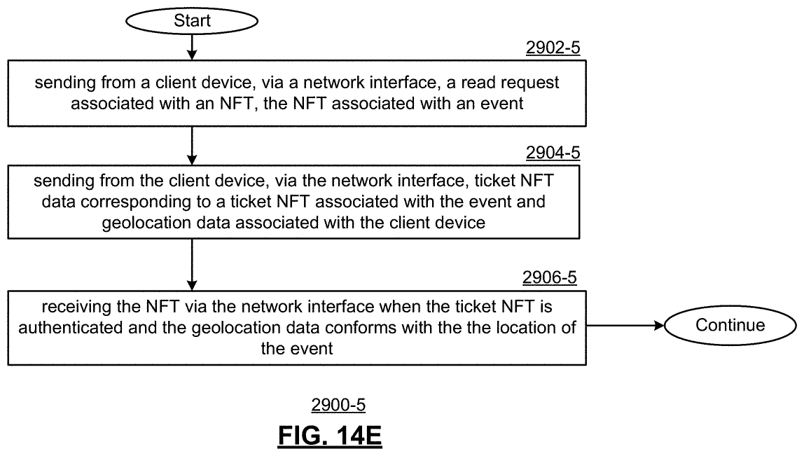

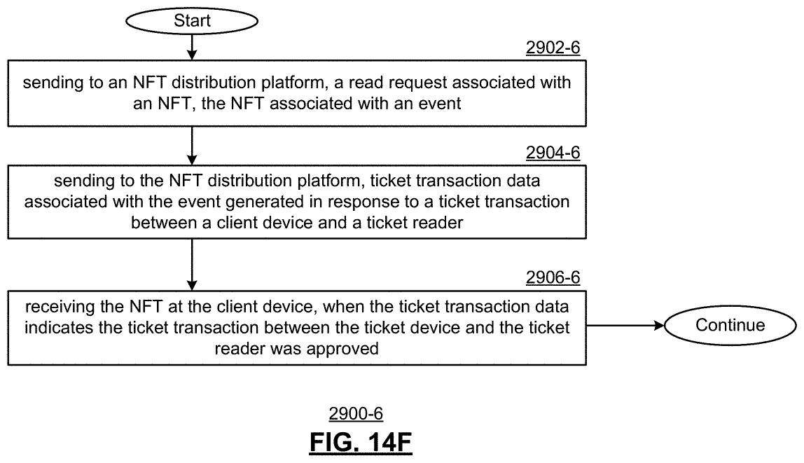

FIG. 14A presents a flowchart representation of an example method. In particular, a method 2900-1 is presented for use in conjunction with any of the functions and features previously described. Step 2902-1 includes sending to a NFT distribution platform and via a network interface, geolocation data associated with the client device. Step 2904-1 includes generating a prompt associated with an NFT, the NFT including restriction data associated with one or more geographical restrictions, wherein the prompt is triggered when the geolocation data associated with the client device conforms with the restriction data. Step 2906-1 includes sending the NFT distribution platform and via the network interface a read request for the NFT. Step 2908-1 includes receiving the NFT from the NFT distribution platform in response to the read request.

FIG. 14B presents a flowchart representation of an example method. In particular, a method 2900-2 is presented for use in conjunction with any of the functions and features previously described. Step 2902-2 includes sending from a client device, via a network interface, a read request associated with an NFT, the NFT associated with an event. Step 2904-2 includes sending from the client device, via the network interface, ticket data associated with a ticket to the event. Step 2906-2 includes receiving the NFT via the network interface when the ticket data conforms with the event data associated with the event.

FIG. 14C presents a flowchart representation of an example method. In particular, a method 2900-3 is presented for use in conjunction with any of the functions and features previously described. Step 2902-3 includes sending from a client device, via a network interface, a read request associated with an NFT, the NFT associated with an event. Step 2904-3 includes sending from the client device, via the network interface, ticket data associated with a ticket to the event and geolocation data. Step 2906-3 includes receiving the NFT in response to a determining that the ticket data conforms with the event data associated with the event.

FIG. 14D presents a flowchart representation of an example method. In particular, a method 2900-4 is presented for use in conjunction with any of the functions and features previously described. Step 2902-4 includes sending from a client device, via a network interface, a read request associated with an NFT, the NFT associated with an event. Step 2904-4 includes sending from the client device, via the network interface, ticket NFT data corresponding to a ticket NFT associated with the event. Step 2906-4 includes receiving the NFT via the network interface when the ticket NFT is authenticated.

FIG. 14E presents a flowchart representation of an example method. In particular, a method 2900-5 is presented for use in conjunction with any of the functions and features previously described. Step 2902-5 includes sending from a client device, via a network interface, a read request associated with an NFT, the NFT associated with an event. Step 2904-5 includes sending from the client device, via the network interface, ticket NFT data corresponding to a ticket NFT associated with the event and geolocation data associated with the client device. Step 2906.5 includes receiving the NFT via the network interface when the ticket NFT is authenticated and the geolocation data conforms with the location of the event.

FIG. 14F presents a flowchart representation of an example method. In particular, a method 2900-6 is presented for use in conjunction with any of the functions and features previously described. Step 2902-1 includes sending to an NFT distribution platform, a read request associated with an NFT, the NFT associated with an event. Step 2904-6 includes sending to the NFT distribution platform, ticket transaction data associated with the event generated in response to a ticket transaction between a client device and a ticket reader. Step 2906-6 includes receiving the NFT at the client device, when the ticket transaction data indicates the ticket transaction between the ticket device and the ticket reader was approved.

As used herein, the terms “game piece” and “game character” can be used interchangeably to refer to a game character, an ancillary article or other article or object that is used in a game.

As used herein “blockchain” and “blockchain node” refer to traditional blockchain technology. However, other decentralized computer network technologies that, for example, maintain a secure and decentralized record of transactions and/or otherwise protect the security of digital information can likewise be employed. In various examples, a blockchain can operate to collect information together in groups, such as blocks, that hold sets of information. These blocks have certain storage capacities and, when filled, are closed and linked to the previously filled blocks, forming a chain of data. New information that follows that freshly added block is compiled into newly formed blocks that, once filled, can also be added to the chain.

As used herein the term “tool” corresponds to a utility, application and/or other software routine that performs one or more specific functions in conjunction with a computer.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., indicates an advantageous relationship that would be evident to one skilled in the art in light of the present disclosure, and based, for example, on the nature of the signals/items that are being compared. As may be used herein, the term “compares unfavorably”, indicates that a comparison between two or more items, signals, etc., fails to provide such an advantageous relationship and/or that provides a disadvantageous relationship. Such an item/signal can correspond to one or more numeric values, one or more measurements, one or more counts and/or proportions, one or more types of data, and/or other information with attributes that can be compared to a threshold, to each other and/or to attributes of other information to determine whether a favorable or unfavorable comparison exists. Examples of such a advantageous relationship can include: one item/signal being greater than (or greater than or equal to) a threshold value, one item/signal being less than (or less than or equal to) a threshold value, one item/signal being greater than (or greater than or equal to) another item/signal, one item/signal being less than (or less than or equal to) another item/signal, one item/signal matching another item/signal, one item/signal substantially matching another item/signal within a predefined or industry accepted tolerance such as 1%, 5%, 10% or some other margin, etc. Furthermore, one skilled in the art will recognize that such a comparison between two items/signals can be performed in different ways. For example, when the advantageous relationship is that signal 1 has a greater magnitude than signal 2, a favorable comparison may be achieved when the magnitude of signal 1 is greater than that of signal 2 or when the magnitude of signal 2 is less than that of signal 1. Similarly, one skilled in the art will recognize that the comparison of the inverse or opposite of items/signals and/or other forms of mathematical or logical equivalence can likewise be used in an equivalent fashion. For example, the comparison to determine if a signal X>5 is equivalent to determining if −X<−5, and the comparison to determine if item/signal A matches item/signal B can likewise be performed by determining −A matches −B or not(A) matches not(B). As may be discussed herein, the determination that a particular relationship is present (either favorable or unfavorable) can be utilized to automatically trigger a particular action. Unless expressly stated to the contrary, the absence of that particular condition may be assumed to imply that the particular action will not automatically be triggered. In other examples, the determination that a particular relationship is present (either favorable or unfavorable) can be utilized as a basis or consideration to determine whether to perform one or more actions. Note that such a basis or consideration can be considered alone or in combination with one or more other bases or considerations to determine whether to perform the one or more actions. In one example where multiple bases or considerations are used to determine whether to perform one or more actions, the respective bases or considerations are given equal weight in such determination. In another example where multiple bases or considerations are used to determine whether to perform one or more actions, the respective bases or considerations are given unequal weight in such determination.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more examples have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more examples are used herein to illustrate one or more aspects, one or more features, one or more concepts, and/or one or more examples. A physical example of an apparatus, an article of manufacture, a machine, and/or of a process may include one or more of the aspects, features, concepts, examples, etc. described with reference to one or more of the examples discussed herein. Further, from figure to figure, the examples may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the examples. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e. machine/non-human intelligence.

One or more functions associated with the methods and/or processes described herein involve NFTs that are generated (“minted”) and secured via blockchain or other decentralized computer network technology. The distributed nature of these technologies over different nodes, the contemporaneous nature of geographically distinct calculations, coupled with the extreme computational complexity of the required calculations means that these decentralized computer network technologies cannot practically be performed by the human mind.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more examples have been expressly described herein, other combinations of these features and functions are likewise possible. The present disclosure is not limited by the particular examples disclosed herein and expressly incorporates these other combinations.

What is claimed is:

1. A system comprising:
a network interface configured to communicate via a network;
a processor;
a memory configured to store operational instructions, that when executed by the processor, cause the processor to perform operations that include:
receiving from a client device, via the network interface, a read request associated with an NFT, the NFT associated with an event;
receiving from the client device, via the network interface, ticket data associated with a ticket to the event;
determining, via the processor, when the ticket data conforms with event data associated with the event; and
sending the NFT to the client device via the network interface when the ticket data conforms with the event data associated with the event.

2. The system of claim 1, wherein the ticket data includes ticket image data of the ticket generated via the client device.

3. The system of claim 2, wherein determining when the ticket data conforms with the event data associated with the event, includes authenticating the ticket, based on the ticket image data.

4. The system of claim 1, wherein the ticket data includes ticket transaction data corresponding to a ticket transaction between the client device and a ticket reader.

5. The system of claim 4, wherein determining when the ticket data conforms with the event data associated with the event, includes validating the ticket transaction data.

6. The system of claim 1, wherein the ticket data includes ticket NFT data corresponding to a ticket NFT associated with the ticket.

7. The system of claim 6, wherein determining when the ticket data conforms with the event data associated with the event, includes authenticating the ticket NFT.

8. The system of claim 1, wherein the operations further include:
receiving geolocation data from the client device;
determining, via the processor, when the geolocation data conforms with a location of the event; and
wherein the NFT is sent to the client device via the network interface only when the geolocation data conforms with the location of the event.

9. The system of claim 8, wherein the geolocation data indicates a location of the client device.

10. The system of claim 9, wherein determining when the geolocation data conforms with the location of the event includes determining the location of the client device is within a predetermined proximity of the location.

11. A method comprising:
receiving from a client device, via a network interface, a read request associated with an NFT, the NFT associated with an event;
receiving from the client device, via the network interface, ticket data associated with a ticket to the event;
determining, via a processor, when the ticket data conforms with event data associated with the event; and
sending the NFT to the client device via the network interface when the ticket data conforms with the event data associated with the event.

12. The method of claim 11, wherein the ticket data includes ticket image data of the ticket generated via the client device.

13. The method of claim 12, wherein determining when the ticket data conforms with the event data associated with the event, includes authenticating the ticket, based on the ticket image data.

14. The method of claim 11, wherein the ticket data includes ticket transaction data corresponding to a ticket transaction between the client device and a ticket reader.

15. The method of claim 14, wherein determining when the ticket data conforms with the event data associated with the event, includes validating the ticket transaction data.

16. The method of claim 11, wherein the ticket data includes ticket NFT data corresponding to a ticket NFT associated with the ticket.

17. The method of claim 16, wherein determining when the ticket data conforms with the event data associated with the event, includes authenticating the ticket NFT.

18. The method of claim 11, further comprising:
receiving geolocation data from the client device;
determining, via the processor, when the geolocation data conforms with a location of the event; and
wherein the NFT is sent to the client device via the network interface only when the geolocation data conforms with the location of the event.

19. The method of claim 18, wherein the geolocation data indicates a location of the client device.

20. The method of claim 19, wherein determining when the geolocation data conforms with the location of the event includes determining the location of the client device is within a predetermined proximity of the location.
